(19) United States
(12) Patent Application Publication
(10) Pub. No.: US 2026/0269597 A1
(43) Pub. Date: Sep. 10, 2026

(54) VEHICLE CONTROL DEVICE

(71) Applicants: DENSO CORPORATION, Kariya-city (JP); DENSO ELECTRONICS CORPORATION, Anjo-city (JP)

(72) Inventors: Yoshifumi KISHIMOTO, Kariya-city (JP); Noriaki Okada, Kariya-city (JP); Keisuke Sanda, Kariya-city (JP); Akimitsu Inoue, Kariya-city (JP); Jun Fukuhara, Kariya-city (JP); Shigekazu Sugimoto, Anjo-city (JP); Akira Sugiura, Anjo-city (JP); Naoyuki Yasuda, Anjo-city (JP)

(21) Appl. No.: 19/660,624

(22) Filed: Apr. 28, 2026

Related U.S. Application Data
(63) Continuation of application No. PCT/JP2024/032617, filed on Sep. 12, 2024.

(30) Foreign Application Priority Data
Oct. 31, 2023 (JP) 2023-186044

(51) Int. Cl. H02H 3/16; B60R 16/03; H02H 3/04; H02H 3/087; H02H 3/10; H02H 3/20

(52) U.S. Cl. CPC H02H 3/16; B60R 16/03; H02H 3/04; H02H 3/087; H02H 3/105; H02H 3/202

(57) ABSTRACT

A vehicle control device includes power supply terminal units, load terminal units, a first power supply line section, a second power supply line section, and a trunk cutoff circuit. The power supply terminal units are electrically connected to the power supply units. The load terminal units are electrically connected to the load units. The first power supply line section is electrically connected to a first power supply terminal included in the power supply terminal units. The second power supply line section is electrically connected to a second power supply terminal included in the power supply terminal units. The trunk cutoff circuit electrically connects the first power supply line section to the second power supply line section, and electrically disconnects the first power supply line section from the second power supply line section based on abnormality of at least one of a current value and a voltage value.

### CROSS REFERENCE TO RELATED APPLICATIONS

The present application is a continuation application of International Patent Application No. PCT/JP2024/032617 filed on Sep. 12, 2024, which designated the U.S. and claims the benefit of priority from Japanese Patent Application No. 2023-186044 filed on Oct. 31, 2023. The entire disclosures of all of the above applications are incorporated herein by reference.

### TECHNICAL FIELD

The present disclosure relates to a vehicle control device.

### BACKGROUND

A power supply device may supply electric power supplied from power sources to a load unit as a type of control device for a vehicle. This power supply device may include a switch unit that cuts off electric power supplied from the power source based on a detection result of a current detected by a current detection unit.

### SUMMARY

According to an aspect of the present disclosure, a vehicle control device controls distribution of electric power supplied from power supply units to load units in a vehicle. The vehicle control device includes power supply terminal units, load terminal units, a first power supply line section, a second power supply line section, and a trunk cutoff circuit. The power supply terminal units are electrically connected to the power supply units. The load terminal units are electrically connected to the load units. The first power supply line section is electrically connected to a first power supply terminal included in the power supply terminal units. The second power supply line section is electrically connected to a second power supply terminal included in the power supply terminal units. The trunk cutoff circuit may electrically connect the first power supply line section to the second power supply line section, and may electrically disconnect the first power supply line section from the second power supply line section based on abnormality of at least one of a current value and a voltage value.

### BRIEF DESCRIPTION OF DRAWINGS

FIG. 1 is a circuit diagram showing a configuration of a power distribution ECU according to an embodiment of the present disclosure.

FIG. 2 is a circuit diagram showing a configuration of a power supply cutoff circuit.

FIG. 3 is a circuit diagram showing a configuration of a trunk cutoff circuit.

FIG. 4 is a circuit diagram showing a configuration of a load cutoff circuit.

FIG. 5 is a flowchart showing details of a startup process performed by the power distribution ECU.

FIG. 6 is a diagram showing the power distribution ECU in abnormality scene 1.

FIG. 7 is a diagram showing the power distribution ECU performing a cutoff process of operation pattern 1.

FIG. 8 is a diagram showing the power distribution ECU performing the cutoff process of operation pattern 1.

FIG. 9 is a flowchart showing details of the cutoff process of operation pattern 1.

FIG. 10 is a diagram showing the power distribution ECU in abnormality scene 2.

FIG. 11 is a diagram showing the power distribution ECU performing a cutoff process of operation pattern 2.

FIG. 12 is a flowchart showing details of the cutoff process of operation pattern 2.

FIG. 13 is a diagram showing the power distribution ECU in abnormality scene 3.

FIG. 14 is a diagram showing the power distribution ECU performing a cutoff process of operation pattern 3.

FIG. 15 is a flowchart showing details of the cutoff process of operation pattern 3.

FIG. 16 is a diagram showing the power distribution ECU in abnormality scene 4.

FIG. 17 is a diagram showing the power distribution ECU performing a cutoff process of operation pattern 4.

FIG. 18 is a flowchart showing details of the cutoff process of operation pattern 4.

FIG. 19 is a diagram showing the power distribution ECU in abnormality scene 5.

FIG. 20 is a diagram showing the power distribution ECU performing a cutoff process of operation pattern 5.

FIG. 21 is a flowchart showing details of the cutoff process of operation pattern 5.

FIG. 22 is a diagram showing the power distribution ECU in abnormality scene 6.

FIG. 23 is a diagram showing the power distribution ECU performing a cutoff process of operation pattern 6.

FIG. 24 is a flowchart showing details of the cutoff process of operation pattern 6.

FIG. 25 is a diagram showing the power distribution ECU in abnormality scene 7.

FIG. 26 is a diagram showing the power distribution ECU performing a cutoff process of operation pattern 7.

FIG. 27 is a flowchart showing details of the cutoff process of operation pattern 7.

FIG. 28 is a diagram showing the power distribution ECU in abnormality scene 8.

FIG. 29 is a diagram showing the power distribution ECU performing a cutoff process of operation pattern 8.

FIG. 30 is a flowchart showing details of the cutoff process of operation pattern 8.

FIG. 31 is a circuit diagram showing a configuration of a trunk cutoff circuit according to Modification 2.

FIG. 32 is a circuit diagram showing a configuration of a load cutoff circuit according to Modification 3.

### DETAILED DESCRIPTION

In recent years, a function of distributing electric power to load units has been required. However, a comparative power supply device may not have a function of distributing electric power to load units. Therefore, naturally, when abnormality occurs in a circuit related to the power supply device, it is impossible with the comparative power supply device to appropriately supply electric power to the load unit.

According to an aspect of the present disclosure, a vehicle control device controls distribution of electric power supplied from power supply units to load units in a vehicle. The vehicle control device includes power supply terminal units, load terminal units, a first power supply line section, a second power supply line section, and a trunk cutoff circuit. The power supply terminal units are electrically connected to the power supply units. The load terminal units are electrically connected to the load units. The first power supply line section is electrically connected to a first power supply terminal included in the power supply terminal units. The second power supply line section is electrically connected to a second power supply terminal included in the power supply terminal units. The trunk cutoff circuit electrically connects the first power supply line section to the second power supply line section, and electrically disconnects the first power supply line section from the second power supply line section based on abnormality of at least one of a current value and a voltage value.

In this aspect, the electrical connection between the first power supply line section and the second power supply line section is cut off by the trunk cutoff circuit unit based on the abnormality of at least one of the current value and the voltage value, and the first power supply line section and the second power supply line section can be electrically separated. According to the above, even when abnormality occurs in a circuit related to the vehicle control device, it becomes possible to appropriately perform power supply from the power supply units to the load terminals, and eventually power supply to the load unit connected to each load terminal.

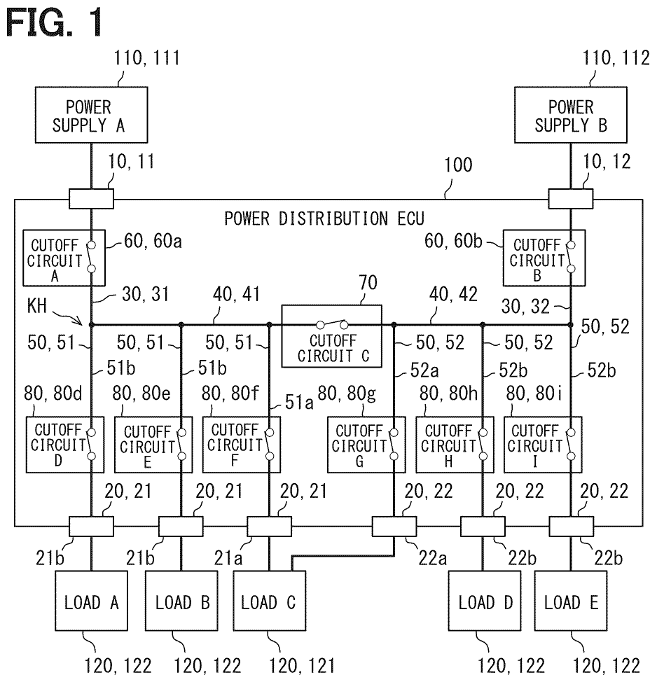

A power distribution ECU (Electronic Control Unit) 100 according to an embodiment of the present disclosure shown in FIG. 1 is a vehicle control device used in a vehicle. The power distribution ECU 100 is mounted on a vehicle and connected to power supply units 110 and load units 120. The power distribution ECU 100 distributes electric power supplied from the power supply units 110 to the large number of load units 120. The power distribution ECU 100 may be a single control device integrating power distribution functions in the vehicle, or may be a configuration implemented in a control device together with other functional units.

The power distribution ECU 100 is implemented in a zone ECU as an example. The zone ECU constructs an in-vehicle network system together with a central ECU, in-vehicle devices, communication lines, and the like. The zone ECU is arranged in each of zones set in advance in the vehicle. One of the zone ECUs also serves as the power distribution ECU 100. The zone ECU has a gateway function, and enables mutual communication by performing conversion and relay of data between networks having different communication methods. The zone ECU controls the in-vehicle devices based on a command of the central ECU. The zone ECU having the function of the power distribution ECU 100 controls distribution of electric power to other zone ECUs, and individual ECUs, actuators, sensors, and the like constituting the in-vehicle devices.

### Configuration of Power Supply Unit and Load Unit

First, details of the power supply unit 110 and the load unit 120 connected to the power distribution ECU 100 will be described.

The power supply unit 110 is a power source mounted on the vehicle. The power supply unit 110 is capable of supplying electric power to the power distribution ECU 100. The power supply unit 110 includes a main power supply 111 (Power Source A in FIG. 1) and an auxiliary power supply 112 (Power Source B in FIG. 1). The main power supply 111 is the power supply unit 110 having a higher power supply capacity than the auxiliary power supply 112. The main power supply 111 is, for example, a DC-DC converter of the vehicle. The auxiliary power supply 112 is the power supply unit 110 having a lower power supply capacity than the main power supply 111. The auxiliary power supply 112 is, for example, an auxiliary battery mounted on the vehicle. The power supply capacity of the main power supply 111 may be several times to ten and several times the power supply capacity of the auxiliary power supply 112.

### Configuration of Load Unit

The load unit 120 is the above-described zone ECU, individual ECU, actuator, sensor, or the like. The load unit 120 consumes the electric power distributed by the power distribution ECU 100 to realize a predetermined function. The load unit 120 includes a priority load 121 (Load C in FIG. 1) and a normal load 122 (Load A, B, D, E in FIG. 1). The priority load 121 is the load unit 120 to which power supply is prioritized over the normal load 122. As an example, the load unit 120 requiring redundancy is set as the priority load 121. Specifically, in-vehicle devices related to an electric power steering and brake system, other zone ECUs, and the like become the priority load 121 having a high priority function. The load unit 120 other than such a priority load 121 is set as the normal load 122. The normal load 122 is the load unit 120 requiring no redundancy, and is a low priority (non-priority) load unit 120 having only a low priority function.

### Configuration of Power Distribution ECU

Next, a configuration of the power distribution ECU 100 will be described. The power distribution ECU 100 includes power supply terminals 10, load terminals 20, power feeding wiring KH, and cutoff circuits.

The power supply terminal 10 is electrically connected to the power supply unit 110. The power supply terminal 10 is configured integrally with a connector exposed to the outside of a housing of the control device. Electric power of the power supply unit 110 is supplied to the power supply terminal 10 through a wire harness or the like connected to the connector. The power supply terminal 10 includes a first power supply terminal 11 and a second power supply terminal 12. The first power supply terminal 11 is electrically connected to the main power supply 111. Electric power is supplied from the main power supply 111 to the first power supply terminal 11. The second power supply terminal 12 is electrically connected to the auxiliary power supply 112. Electric power is supplied from the auxiliary power supply 112 to the second power supply terminal 12. Larger electric power is supplied to the first power supply terminal 11 than to the second power supply terminal 12. Therefore, the first power supply terminal 11 is formed larger than the second power supply terminal 12 so as to be able to handle large electric power.

The load terminal 20 is electrically connected to the load unit 120. The load terminal 20 is configured integrally with a connector exposed to the outside of the housing of the control device. The load terminal 20 supplies electric power to the load unit 120 through a wire harness or the like connected to the connector. The load terminal 20 includes a first load terminal 21 and a second load terminal 22. The first load terminal 21 is electrically connected to the first power supply line section 31 via a first load line section 51 and a first portion 41 described later. The second load terminal 22 is electrically connected to the second power supply line section 32 via a second load line section 52 and a second portion 42 described later.

The first load terminal 21 further includes a first priority terminal 21a and a first normal terminal 21b. The second load terminal 22 further includes a second priority terminal 22a and a second normal terminal 22b. The first priority terminal 21a and the second priority terminal 22a are electrically connected to the priority load 121. The first normal terminal 21b and the second normal terminal 22b are electrically connected to the normal load 122.

One of the first priority terminals 21a and one of the second priority terminals 22a are electrically connected to the same priority load 121. The first priority terminal 21a and the second priority terminal 22a connected to the same priority load 121 are adjacent to each other. Specifically, a first priority connector including the first priority terminal 21a and a second priority connector including the second priority terminal 22a have the same shape as each other. The first priority connector and the second priority connector are arranged adjacent to the outside of the housing. Pin arrangements inside the first priority connector and the second priority connector are the same as each other. Further, the first priority connector and the second priority connector may be integrally formed. Even with such integral formation of connectors, the first priority terminal 21a and the second priority terminal 22a are configured to be adjacent to each other.

The power feeding wiring KH is wiring formed between the power supply terminals 10 and the load terminals 20. The power feeding wiring KH is formed by a copper conductive layer (wiring pattern) provided on a printed wiring board constituting the power distribution ECU 100. A bus bar mounted on the printed wiring board along the wiring pattern may form a part of the power feeding wiring KH. The bus bar is implemented in parallel with the wiring pattern at a location where the current cannot be sufficiently carried by the wiring pattern alone. The power feeding wiring KH is constituted by a power supply wiring 30, a power supply trunk 40, a load wiring 50, and the like.

The power supply wiring 30 is wiring connected to the power supply terminal 10. The power supply wiring 30 includes a first power supply line section 31 and a second power supply line section 32. The first power supply line section 31 is a wiring portion connected to the first power supply terminal 11. Electric power from the main power supply 111 is supplied to the first power supply line section 31. The wiring width (wiring cross-sectional area) of the first power supply line section 31 is made wider (larger) than the wiring width of the second power supply line section 32 so as to be able to handle the large electric power supplied from the main power supply 111. The second power supply line section 32 is a wiring portion connected to the second power supply terminal 12. Electric power from the auxiliary power supply 112 is supplied to the second power supply line section 32. In the power supply wiring 30, a power Zener diode may be arranged in a section between a power supply cutoff circuit 60 described later and the power supply terminal 10. The power Zener diode is a configuration for preventing withstand voltage breakdown of the power supply cutoff circuit 60 when a high voltage is output from the power supply unit 110.

The power supply trunk 40 is wiring electrically connected to both the first power supply line section 31 and the second power supply line section 32. Electric power is supplied to the power supply trunk 40 from each of the main power supply 111 and the auxiliary power supply 112 via the first power supply line section 31 and the second power supply line section 32. The wiring width (wiring cross-sectional area) of the power supply trunk 40 is the same as the wiring width of the first power supply line section 31 or wider (larger) than the wiring width of the first power supply line section 31. A trunk cutoff circuit 70 described later is provided in the middle of the power supply trunk 40. In the power supply trunk 40, a section between the first power supply line section 31 and the trunk cutoff circuit 70 is defined as a first portion 41. The first portion 41 is a main section that receives power supply from the main power supply 111 when the trunk cutoff circuit 70 is in a state of energization cutoff (off). In the power supply trunk 40, a section between the second power supply line section 32 and the trunk cutoff circuit 70 is defined as a second portion 42. The second portion 42 is an auxiliary portion that receives power supply from the auxiliary power supply 112 when the trunk cutoff circuit 70 is in the state of energization cutoff (off).

The load wiring 50 is wiring connected to the load terminal 20. The wiring width (wiring cross-sectional area) of the load wiring 50 is narrower (smaller) than the wiring width of the power supply trunk 40. Wiring widths of the respective load wirings 50 may be different from each other. The load wiring 50 includes a first load line section 51 and a second load line section 52. The first load line section 51 electrically connects the first load terminal 21 and the first portion 41 which is on the first power supply line section 31 side relative to the trunk cutoff circuit 70 in the power supply trunk 40. Of the first load line sections 51, the load wiring 50 connecting the first priority terminal 21a to the power supply trunk 40 is a first priority line section 51a. Of the first load line sections 51, the load wiring 50 connecting the first normal terminal 21b to the power supply trunk 40 is a first normal line section 51b. The second load line section 52 electrically connects the second load terminal 22 and the second portion 42 which is on the second power supply line section 32 side relative to the trunk cutoff circuit 70 in the power supply trunk 40. Of the second load line sections 52, the load wiring 50 connecting the second priority terminal 22a to the power supply trunk 40 is a second priority line section 52a. Of the second load line sections 52, the load wiring 50 connecting the second normal terminal 22b to the power supply trunk 40 is a second normal line section 52b.

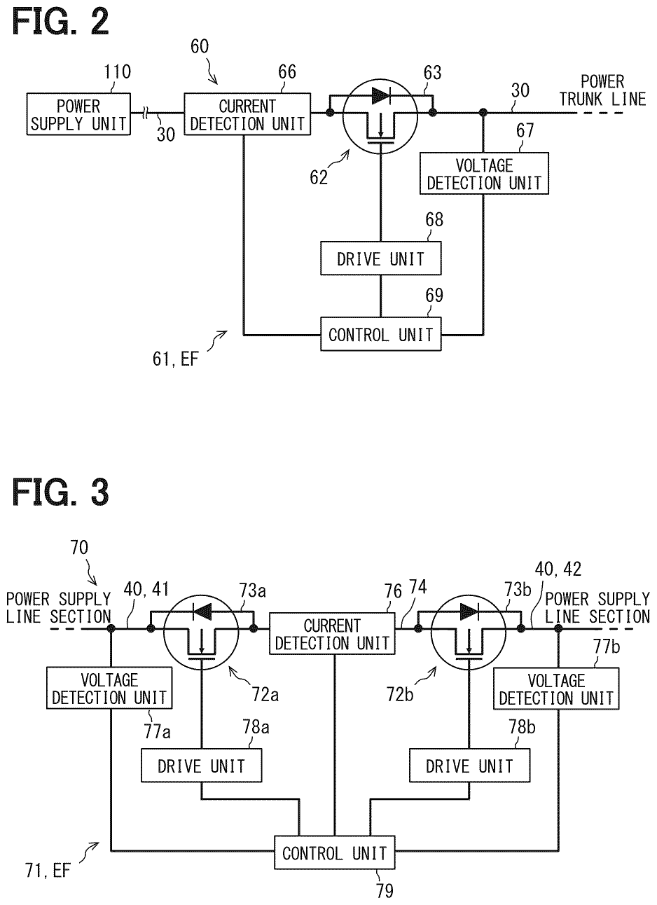

The cutoff circuit includes an electric fuse EF (see FIGS. 2 to 4). A large number of fuses EF are mounted on the printed wiring board constituting the power distribution ECU 100. Cutoff circuits such as the power supply cutoff circuit 60, the trunk cutoff circuit 70, and the load cutoff circuit 80 are formed in the power feeding wiring KH by the large number of fuses EF. When the cutoff circuit is in an on state, two wirings connected to the cutoff circuit are in an energized state of being electrically connected. On the other hand, when the cutoff circuit is in an off state, the two wirings connected to the cutoff circuit are in a state where energization is cut off.

The power supply cutoff circuit 60 (see FIG. 2) is a cutoff circuit provided in the power supply wiring 30. The power supply cutoff circuit 60 cuts off an electrical connection between the power supply terminal 10 and the load terminal 20 (power supply trunk 40). Two power supply cutoff circuits 60 are provided in the power feeding wiring KH. The power supply cutoff circuit 60 (Cutoff Circuit A in FIG. 1) arranged in the first power supply line section 31 is a first cutoff circuit 60a. The power supply cutoff circuit 60 (Cutoff Circuit B in FIG. 1) arranged in the second power supply line section 32 is a second cutoff circuit 60b. The first cutoff circuit 60a cuts off an electrical connection between the first power supply terminal 11 and the first portion 41 based on abnormality of at least one of a current value and a voltage value in the first power supply line section 31. The second cutoff circuit 60b cuts off an electrical connection between the second power supply terminal 12 and the second portion 42 based on abnormality of at least one of a current value and a voltage value in the second power supply line section 32.

The trunk cutoff circuit 70 (see FIG. 3) is a cutoff circuit (Cutoff Circuit C in FIG. 1) provided in the power supply trunk 40. The trunk cutoff circuit 70 corresponds to an isolator, a backbone switch, and the like. The trunk cutoff circuit 70 is arranged in the middle of the power supply trunk 40, and electrically connects between the first power supply line section 31 and the second power supply line section 32. The trunk cutoff circuit 70 cuts off an electrical connection between the first portion 41 and the second portion 42, and eventually an electrical connection between the first power supply line section 31 and the second power supply line section 32, based on abnormality of at least one of a current value and a voltage value in the power supply trunk 40. When the trunk cutoff circuit 70 is in the on state where the electrical connection between the first power supply line section 31 and the second power supply line section 32 is not cut off, the first power supply terminal 11 is electrically connected to the second load terminal 22. On the other hand, when the trunk cutoff circuit 70 is in the off state where the electrical connection between the first power supply line section 31 and the second power supply line section 32 is cut off, the first power supply terminal 11 is electrically cut off from the second load terminal 22. Further, when the trunk cutoff circuit 70 is in the on state, the second power supply terminal 12 is electrically connected to the first load terminal 21. On the other hand, when the trunk cutoff circuit 70 is in the off state, the second power supply terminal 12 is electrically cut off from the first load terminal 21.

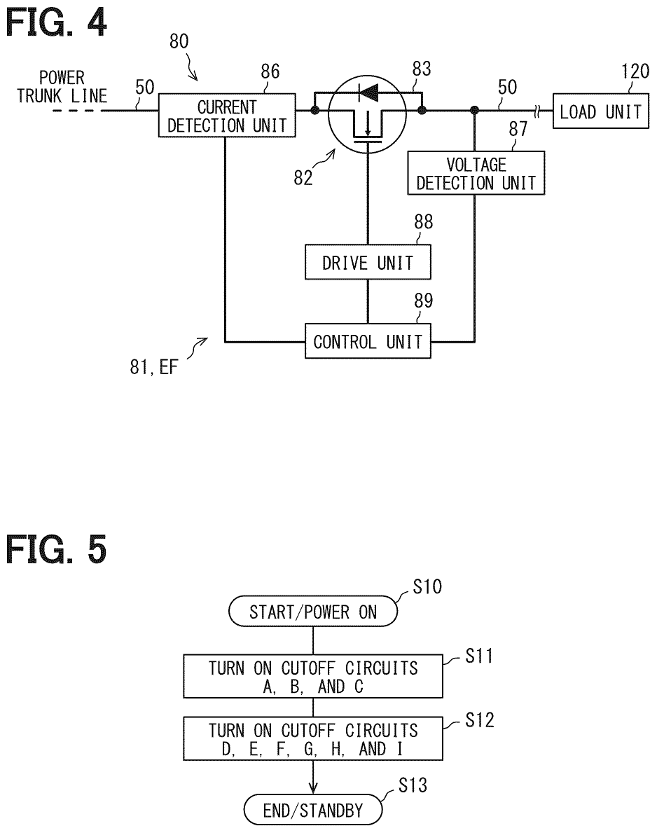

The load cutoff circuit 80 (see FIG. 4) is a cutoff circuit provided in the load wiring 50. One load cutoff circuit 80 is provided in the middle of each of the first load line sections 51 and the second load line sections 52 (Cutoff Circuits D to I in FIG. 1). The load cutoff circuit 80 cuts off an electrical connection between the power supply trunk 40 and the load terminal 20 based on abnormality of at least one of a current value and a voltage value in the load wiring 50.

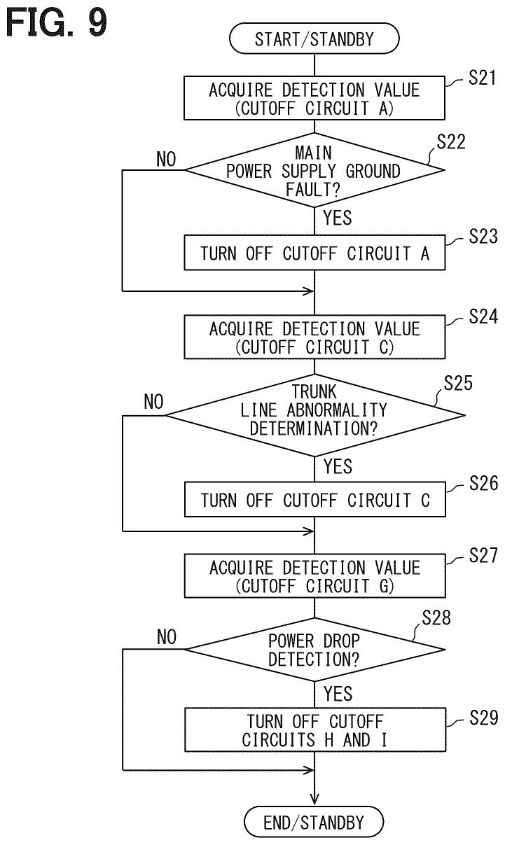

The load cutoff circuits 80 can share information with each other. Therefore, the load cutoff circuit 80 can cut off an electrical connection by the load wiring 50 based on abnormality detected by another load cutoff circuit 80. As an example, the load cutoff circuit 80 of the normal line sections 51b, 52b cuts off an electrical connection between the power supply trunk 40 and the normal terminals 21b, 22b based on abnormality of a current value or a voltage value detected by the load cutoff circuit 80 of the priority line sections 51a, 52a (see FIG. 9 etc.).

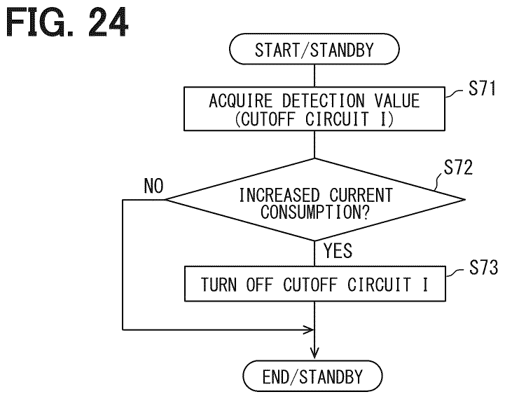

In addition, the load cutoff circuit 80 and the trunk cutoff circuit 70 can share information with each other. Therefore, the load cutoff circuit 80 cuts off an electrical connection between the power supply trunk 40 and the load terminal 20 based on abnormality of a current value or a voltage value of the power supply trunk 40 detected by the trunk cutoff circuit 70. Similarly, the trunk cutoff circuit 70 cuts off an electrical connection between the first power supply line section 31 and the second power supply line section 32 based on abnormality of a current value or a voltage value of the load wiring 50 detected by the load cutoff circuit 80 (see FIG. 24).

### Configuration of Cutoff Circuit

Next, details of the power supply cutoff circuit 60, the trunk cutoff circuit 70, and the load cutoff circuit 80 will be described based on FIGS. 2 to 4 with reference to FIG. 1.

The power supply cutoff circuit 60 shown in FIG. 2 is a one-way cutoff circuit that cuts off only a current in a reverse direction among a current in a forward direction flowing from the power supply terminal 10 toward the load terminal 20 (power supply trunk 40) and the current in the reverse direction flowing from the load terminal 20 toward the power supply terminal 10. The power supply cutoff circuit 60 does not completely cut off the current in the forward direction. The power supply cutoff circuit 60 has a configuration mainly including a switch unit 61. The switch unit 61 includes an FET (Field Effect Transistor) 62, a current detection unit 66, a voltage detection unit 67, a drive unit 68, and a control unit 69.

The FET 62 is an N-channel MOS (Metal-Oxide-Semiconductor) FET. A source of the FET 62 is connected to the power supply wiring 30 on the power supply unit 110 (power supply terminal 10) side. A drain of the FET 62 is connected to the power supply wiring 30 on the power supply trunk 40 side. A gate of the FET 62 is connected to the drive unit 68. A body diode 63 is formed in the FET 62. An anode of the body diode 63 is connected to the power supply wiring 30 on the power supply unit 110 side. A cathode of the body diode 63 is connected to the power supply wiring 30 on the power supply trunk 40 side.

The current detection unit 66 is arranged in the power supply wiring 30 on the power supply unit 110 side relative to the FET 62. The current detection unit 66 detects a value of a current flowing through the power supply wiring 30 and a flow direction of the current. The current detection unit 66 outputs the detected current value and current direction to the control unit 69. The voltage detection unit 67 is connected to the power supply wiring 30 on the power supply trunk 40 side relative to the FET 62. The voltage detection unit 67 detects a value of a voltage of the power supply wiring 30. The voltage detection unit 67 outputs the detected voltage value to the control unit 69.

The drive unit 68 is connected to the gate of the FET 62. The drive unit 68 applies a predetermined voltage (hereinafter, gate voltage) to the gate of the FET 62 based on a command signal input from the control unit 69. When the drive unit 68 applies the gate voltage, a conductive state (on state) is established between the source and the drain of the FET 62. On the other hand, when the gate voltage is not applied, a non-conductive state (off state) is established between the source and the drain of the FET 62. Note that, by having the body diode 63, the FET 62 allows a flow of current in the forward direction from the source to the drain even when the gate voltage is not applied.

The control unit 69 is connected to the drive unit 68. The control unit 69 switches between on and off states of the FET 62, and eventually between energization and energization cutoff states of the power supply wiring 30, by outputting a command signal to the drive unit 68. The control unit 69 acquires the current value and the current direction detected by the current detection unit 66 and the voltage value detected by the voltage detection unit 67, and electrically reads the latest current value and voltage value of the power supply wiring 30. The control unit 69 determines occurrence of abnormality based on at least one of the current value and the voltage value. The control unit 69 compares at least one of the current value and the voltage value with a preset determination threshold value. Based on processing of comparing the detection value and the determination threshold value, the control unit 69 detects abnormality such as a ground fault, a short circuit, and an open occurring in a power supply system or the power supply wiring 30. When a current flows toward a ground fault path and the voltage value is an abnormal value, the control unit 69 determines that a ground fault has occurred. When a current does not flow and the voltage value is an abnormal value, the control unit 69 determines that an open (OPEN) has occurred. When detecting the occurrence of abnormality, the control unit 69 cooperates with the drive unit 68 to turn off the FET 62 and cut off energization by the power supply wiring 30.

The trunk cutoff circuit 70 shown in FIG. 3 is a bidirectional cutoff circuit that cuts off both a current flowing from the first power supply line section 31 toward the second power supply line section 32 and a current flowing from the second power supply line section 32 toward the first power supply line section 31. The trunk cutoff circuit 70 has a configuration mainly including a switch unit 71. The switch unit 71 switches between energization and energization cutoff between the first power supply line section 31 and the second power supply line section 32 in the power supply trunk 40. The switch unit 71 includes two FETs 72a, 72b, a current detection unit 76, two voltage detection units 77a, 77b, two drive units 78a, 78b, and a control unit 79.

The FETs 72a, 72b are N-channel MOSFETs. The FETs 72a, 72b are connected to each other via an intermediate connection line section 74. Each source of the FETs 72a, 72b is connected to each of both ends of the intermediate connection line section 74. A drain of the FET 72a is connected to the first portion 41. A drain of the FET 72b is connected to the second portion 42. A gate of the FET 72a is connected to the drive unit 78a. A gate of the FET 72b is connected to the drive unit 78b. Body diodes 73a, 73b are formed in the FETs 72a, 72b. Anodes of the body diodes 73a, 73b are connected to the intermediate connection line section 74. A cathode of the body diode 73a is connected to the first portion 41. A cathode of the body diode 73b is connected to the second portion 42.

The current detection unit 76 is arranged in the intermediate connection line section 74. The current detection unit 76 detects a value of a current flowing through the power supply trunk 40 and a flow direction of the current. The current detection unit 76 outputs the detected current value and current direction to the control unit 79. The voltage detection unit 77a is connected to the first portion 41 which is on the first power supply line section 31 side of the FET 72a. The voltage detection unit 77a detects a voltage of the first portion 41. The voltage detection unit 77b is connected to the second portion 42 which is on the second power supply line section 32 side of the FET 72b. The voltage detection unit 77b detects a voltage of the second portion 42. Each voltage detection unit 77a, 77b outputs the detected voltage value to the control unit 79.

The drive units 78a, 78b are connected to the gates of the FETs 72a, 72b, respectively. The drive units 78a, 78b apply a gate voltage to the gates of the FETs 72a, 72b based on a command signal input from the control unit 79. When the drive units 78a, 78b apply the gate voltage, a conductive state is established between the source and the drain of each FET 72a, 72b. On the other hand, when the gate voltage is not applied, a non-conductive state is established between the source and the drain of each FET 72a, 72b. Note that, by combining the two FETs 72a, 72b, when the gate voltage is not applied, a current flowing from the first portion 41 toward the second portion 42 is cut off by the body diode 73a. Also, a current flowing from the second portion 42 toward the first portion 41 is cut off by the body diode 73b.

The control unit 79 is connected to the two drive units 78a, 78b. The control unit 79 switches between on and off states of the respective FETs 72a, 72b, and eventually between energization and energization cutoff states of the power supply trunk 40, by outputting a command signal to each drive unit 78a, 78b. The control unit 79 acquires the current value and the current direction detected by the current detection unit 76 and each voltage value detected by each voltage detection unit 77a, 77b, and electrically reads the latest current value and voltage value of the power supply trunk 40. The control unit 79 determines occurrence of abnormality in the power supply trunk 40, such as a decrease in supplied power and a sudden increase in the current value and the voltage value, based on at least one of the current value and the voltage value. The control unit 79 acquires a signal indicating occurrence of abnormality (hereinafter, abnormality notification signal) from the load cutoff circuit 80 (control unit 89). In addition, when a stuck fault or the like occurs in the switch unit 71, the control unit 79 transmits abnormality notification signal indicating the occurrence of the fault to the load cutoff circuit 80 (control unit 89). When detecting the occurrence of abnormality, or when acquiring the abnormality notification signal from the load cutoff circuit 80, the control unit 79 cooperates with each drive unit 78a, 78b to turn off each FET 72a, 72b and cut off energization of the power supply trunk 40.

The load cutoff circuit 80 shown in FIG. 4 cuts off only a current in a forward direction among the current in the forward direction flowing from the power supply trunk 40 toward the load terminal 20 and a current in a reverse direction flowing from the load terminal 20 toward the power supply trunk 40. The load cutoff circuit 80 does not completely cut off the current in the reverse direction. The load cutoff circuit 80 has a configuration mainly including a switch unit 81. The switch unit 81 includes an FET 82, a current detection unit 86, a voltage detection unit 87, a drive unit 88, and a control unit 89.

The FET 82 is an N-channel MOSFET. A source of the FET 82 is connected to the load wiring 50 on the load unit 120 (load terminal 20) side. A drain of the FET 82 is connected to the load wiring 50 on the power supply trunk 40 side. A gate of the FET 82 is connected to the drive unit 88. A body diode 83 is formed in the FET 82. An anode of the body diode 83 is connected to the load wiring 50 on the load unit 120 side. A cathode of the body diode 83 is connected to the load wiring 50 on the power supply trunk 40 side.

The current detection unit 86 is arranged in the load wiring 50 on the power supply trunk 40 side relative to the FET 82. The current detection unit 86 detects a value of a current flowing through the load wiring 50 and a flow direction of the current. The current detection unit 86 outputs the detected current value and current direction to the control unit 89. The voltage detection unit 87 is connected to the load wiring 50 on the load unit 120 side relative to the FET 82. The voltage detection unit 87 detects a value of a voltage of the load wiring 50. The voltage detection unit 87 outputs the detected voltage value to the control unit 89.

The drive unit 88 is connected to the gate of the FET 82. The drive unit 88 applies a predetermined gate voltage to the gate of the FET 82 based on a command signal input from the control unit 89. When the drive unit 88 applies the gate voltage, a conductive state is established between the source and the drain of the FET 82. On the other hand, when the gate voltage is not applied, a non-conductive state is established between the source and the drain of the FET 82. Note that, by having the body diode 83, the FET 82 allows a flow of current in the reverse direction from the source to the drain even when the gate voltage is not applied.

The control unit 89 is connected to the drive unit 88. The control unit 89 switches between on and off states of the FET 82, and eventually between energization and energization cutoff states of the load wiring 50, by outputting a command signal to the drive unit 88. The control unit 89 acquires the current value and the current direction detected by the current detection unit 86 and the voltage value detected by the voltage detection unit 87, and electrically reads the latest current value and voltage value of the load cutoff circuit 80. The control unit 89 determines occurrence of abnormality in the load wiring 50 based on at least one of the current value and the voltage value. Based on processing of comparing the detection value and the determination threshold value, the control unit 89 detects abnormality such as a decrease in supplied power and a sudden increase in the current value and the voltage value caused by a ground fault, a short circuit, an open, and the like occurring in a load system. When detecting the occurrence of abnormality, the control unit 89 transmits abnormality notification signal indicating the occurrence of the abnormality in the load wiring 50 to the control unit 89 of another load cutoff circuit 80, the control unit 79 of the trunk cutoff circuit 70, and the like. When a stuck fault or the like occurs in the switch unit 81, the control unit 89 transmits abnormality notification signal indicating the occurrence of the fault to other control units 89, the control unit 79, and the like. The control unit 89 acquires abnormality notification signal indicating occurrence of abnormality in another load wiring 50 from another control unit 89. When detecting the occurrence of abnormality or when acquiring the abnormality notification signal from another control unit 89, the control unit 89 cooperates with the drive unit 88 to turn off the FET 82 and cut off energization by the load wiring 50.

### Operation of Cutoff Circuit at Time of Abnormality Occurrence

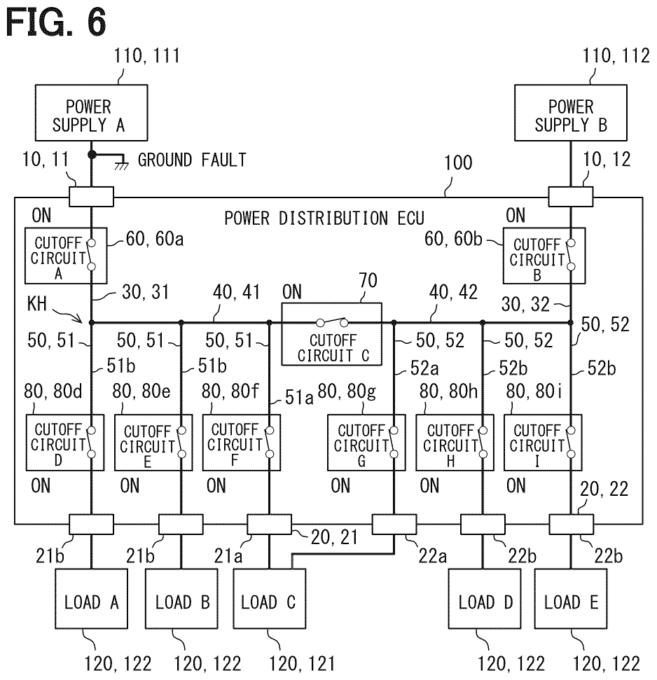

Based on reception of a power-on command signal, the power distribution ECU 100 starts a startup process shown in FIG. 5 (S10). In the startup process, in each power supply cutoff circuit 60 and the trunk cutoff circuit 70, each control unit 69, 79 cooperates with each drive unit 68, 78a, 78b to put each FET 62, 72a, 72b into an energized state (see FIGS. 2 and 3). As a result, the cutoff circuits A, B, and C are turned on (S11). Further, in each load cutoff circuit 80, the control unit 89 cooperates with the drive unit 88 to put the FET 82 into an energized state (see FIG. 4). As a result, the cutoff circuits D to I are turned on (S12). By switching on the respective cutoff circuits A to I, the main power supply 111 and the auxiliary power supply 112 supply electric power to the power distribution ECU 100, and the power distribution ECU 100 enters a state of supplying electric power to the load units 120 (see Load A to E in FIG. 6).

After ending the startup process, the power distribution ECU 100 enters a standby state of waiting for occurrence of abnormality (S13). The standby state continues until the power distribution ECU 100 ends power distribution control, in other words, until the power distribution ECU 100 enters an off state. Then, when abnormality occurs inside the power supply unit 110, the load unit 120, the power distribution ECU 100, or the like, the power distribution ECU 100 performs a cutoff process corresponding to abnormality pattern. The power distribution ECU 100 that has ended the cutoff process enters the standby state again. Hereinafter, operation patterns of the cutoff process performed by the power distribution ECU 100 as abnormality response will be described in order based on FIGS. 6 to 30 with reference to FIGS. 2 to 4.

### Operation Pattern 1: Ground Fault of Main Power Supply System

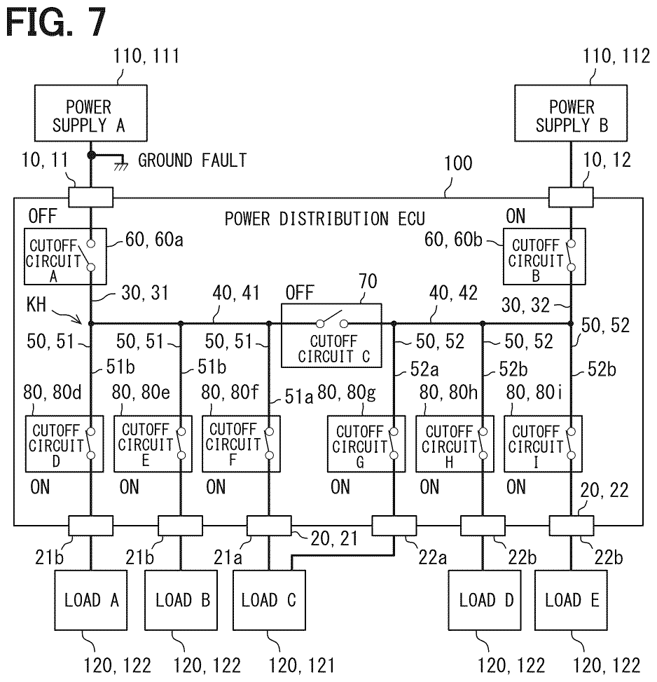

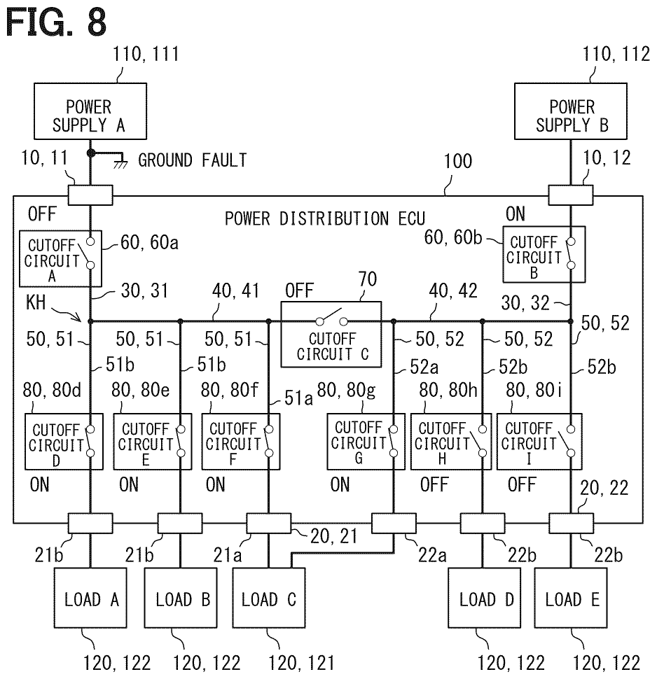

In abnormality scene 1 shown in FIGS. 6 to 8, a ground fault related to the main power supply 111 (Power Source A) has occurred. The ground fault of the main power supply 111 may occur due to, for example, incorrect wiring between the first power supply terminal 11 and the main power supply 111, damage caused by an accident, or the like. When the main power supply 111 has a ground fault, the power distribution ECU 100 performs a cutoff process of operation pattern 1 shown in FIG. 9. In the cutoff process of operation pattern 1, the first portion 41 of the power supply trunk 40 is separated from the auxiliary power supply 112 by switching off the trunk cutoff circuit 70 (Cutoff Circuit C in FIG. 7). Further, by switching off the load cutoff circuits 80h, 80i (Cutoff Circuits H, I in FIG. 8), power distribution prioritizing the priority load 121 (Load C in FIG. 8) is performed.

More specifically, in the cutoff process of operation pattern 1, the control unit 69 of the first cutoff circuit 60a acquires detection values of the current detection unit 66 and the voltage detection unit 67 (S21). The control unit 69 compares at least one of the voltage value and the current value with a determination threshold value, and detects abnormality of the voltage value or the current value in the first power supply line section 31. The control unit 69 determines that the main power supply 111 has a ground fault based on abnormality of at least one of the current value and the voltage value (S22). Specifically, as described above, when a current flows in a reverse direction toward a ground fault path and the voltage value of the first power supply line section 31 is an abnormal value, the control unit 69 determines that the main power supply 111 has a ground fault.

When determining that the main power supply 111 has a ground fault (S22: YES), the control unit 69 cooperates with the drive unit 68 to put the FET 62 into a cutoff state. As a result, the first cutoff circuit 60a (Cutoff Circuit A in FIG. 7) is turned off (S23). According to the above, since the first power supply terminal 11 is separated from the power supply trunk 40, the electrical connection between the first power supply terminal 11 and the load terminal 20 is cut off. Therefore, a decrease in power supply voltage applied from the auxiliary power supply 112 to the power supply trunk 40 is suppressed. Note that if no abnormality of the current value or the voltage value is detected (S22: NO), the off switching of the first cutoff circuit 60a is skipped.

Here, according to the off switching of the first cutoff circuit 60a, the auxiliary power supply 112 supplies electric power to all the load units 120. Therefore, if the power supply capacity of the auxiliary power supply 112 is not sufficient, supplied power to the priority load 121 (Load C in FIG. 7) may be insufficient. To avoid such a situation, the power distribution ECU 100 interrupts the supply of electric power to the normal load 122 (Load A, B, D, E in FIG. 7) in stages.

The control unit 79 of the trunk cutoff circuit 70 acquires detection values of the current detection unit 76 and the voltage detection units 77a, 77b (S24). The control unit 79 compares at least one of the voltage value and the current value with a determination threshold value, and detects occurrence of abnormality in the power supply trunk 40 (S25). When determining that abnormality has occurred in the power supply trunk 40 (S25: YES), the control unit 79 cooperates with the drive units 78a, 78b to put the FETs 72a, 72b into a cutoff state. As a result, the trunk cutoff circuit 70 (Cutoff Circuit C in FIG. 7) is turned off (S26). According to the above, the electrical connection between the second power supply terminal 12 and the first load terminal 21 is cut off, and power supply to the normal load 122 (Load A, B in FIG. 7) is cut. Note that if no abnormality has occurred in the power supply trunk 40 (S25: NO), the off switching of the trunk cutoff circuit 70 is skipped.

Further, when the supplied power to the priority load 121 is still insufficient even after the trunk cutoff circuit 70 is switched off, the power distribution ECU 100 interrupts the supply of electric power to another normal load 122 (Load D, E in FIG. 7). The control unit 89 of the load cutoff circuit 80g arranged in the second priority line section 52a acquires detection values of the current detection unit 86 and the voltage detection unit 87 (S27). The control unit 89 compares at least one of the voltage value and the current value with a determination threshold value, and detects occurrence of abnormality in the second priority line section 52a. Specifically, the control unit 89 detects a decrease in supplied power to the priority load 121 (S28). When detecting a decrease in supplied power (S28: YES), the control unit 89 transmits abnormality notification signal indicating the decrease in supplied power to each control unit 89 of the load cutoff circuits 80h, 80i arranged in the second normal line section 52b.

Based on reception of the abnormality notification signal, each control unit 89 of the load cutoff circuits 80h, 80i cooperates with the drive unit 88 to put the FET 82 into a cutoff state. As a result, the load cutoff circuits 80h, 80i (Cutoff Circuits H, I in FIG. 8) are turned off (S29). According to the above, in each second normal line section 52b, the electrical connection between the second portion 42 and the second normal terminal 22b is cut off, and power supply to the normal load 122 is further cut. As a result, the load on the auxiliary power supply 112 is reduced, and sufficient electric power continues to be supplied to the priority load 121. Note that if a decrease in supplied power is not detected (S28: NO), the off switching of the load cutoff circuits 80h, 80i is skipped.

### Operation Pattern 2: Ground Fault of Main Power Supply System and Stuck Trunk Cutoff Circuit

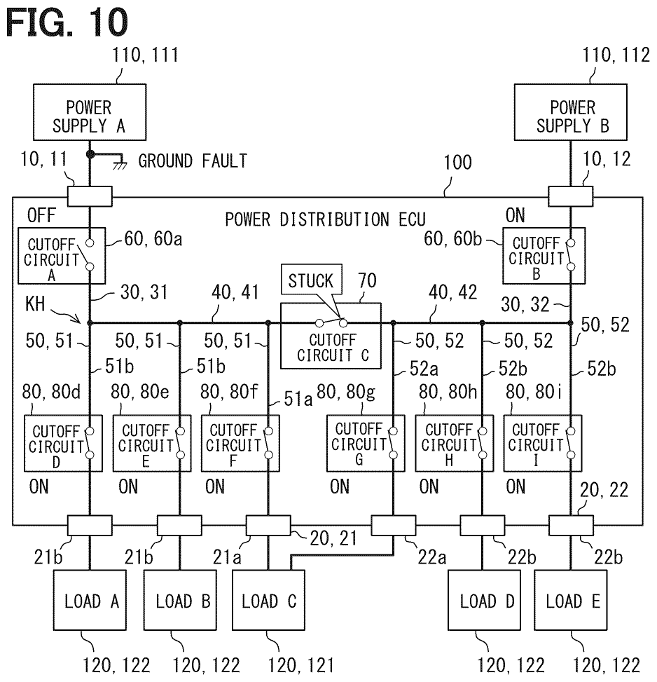

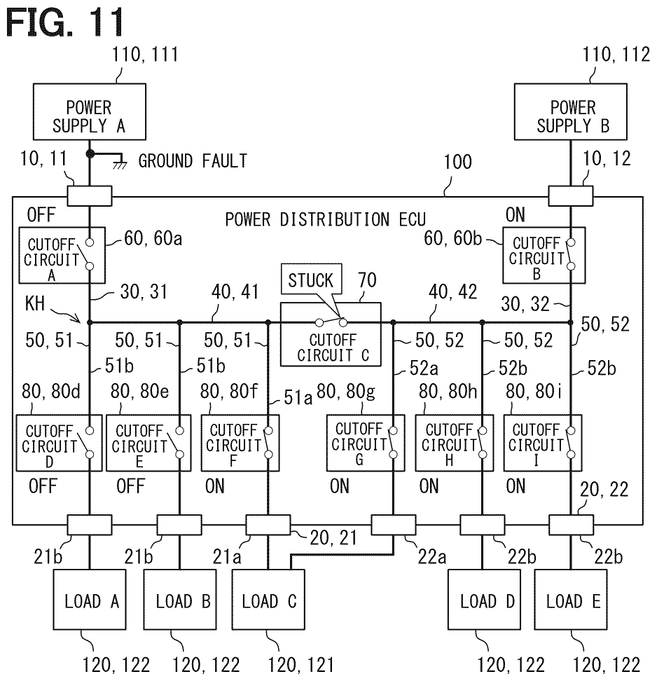

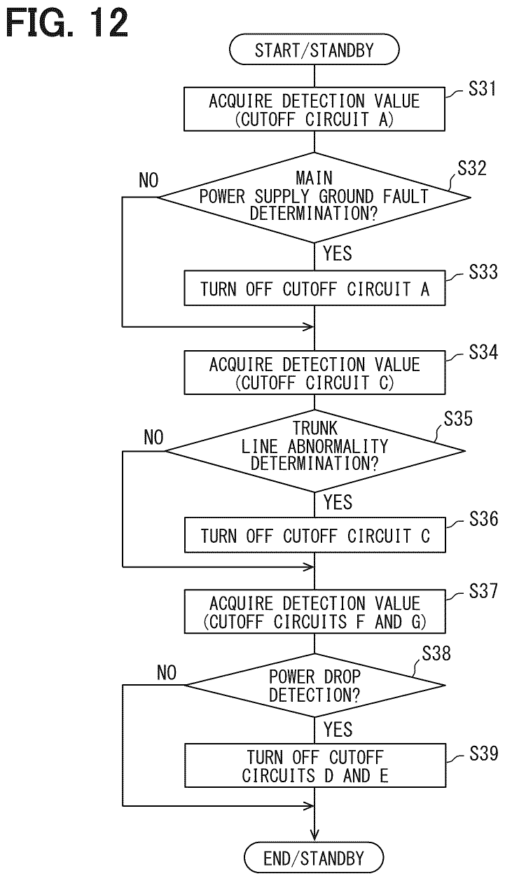

In abnormality scene 2 shown in FIGS. 10 and 11, a ground fault related to the main power supply 111 (Power Source A) has occurred similarly to the abnormality scene 1 described above. In addition, due to stuck of the trunk cutoff circuit 70, energization cutoff of the power supply trunk 40 cannot be performed. In this case, the power distribution ECU 100 performs a cutoff process of operation pattern 2 shown in FIG. 12. S31 to S36 of the cutoff process of operation pattern 2 are substantially the same as S21 to S26 of the cutoff process of operation pattern 1 (see FIG. 9). In the cutoff process of operation pattern 2, power distribution prioritizing the priority load 121 (Load C in FIG. 8) is performed by switching off the load cutoff circuits 80d, 80e (Cutoff Circuits D, E in FIG. 11).

More specifically, in the cutoff process of operation pattern 2, each control unit 89 of the load cutoff circuits 80f, 80g grasps stuck of the trunk cutoff circuit 70 by receiving abnormality notification signal indicating a stuck fault from the control unit 79 of the trunk cutoff circuit 70. Further, the control unit 89 acquires detection values of the current detection unit 86 and the voltage detection unit 87 (S37). The control unit 89 compares at least one of the voltage value and the current value with a determination threshold value, and detects occurrence of abnormality in the priority line sections 51a, 52a. Specifically, the control unit 89 detects a decrease in supplied power to the priority load 121 (S38). When grasping the stuck fault of the trunk cutoff circuit 70 and detecting a decrease in supplied power to the priority load 121 (S38: YES), the control unit 89 transmits abnormality notification signal indicating the decrease in supplied power to each control unit 89 of the load cutoff circuits 80d, 80e of the first normal line section 51b.

Based on reception of the abnormality notification signal, each control unit 89 of the load cutoff circuits 80d, 80e cooperates with the drive unit 88 to put the FET 82 into a cutoff state. As a result, the load cutoff circuits 80d, 80e (Cutoff Circuits D, E in FIG. 11) are turned off (S39). According to the above, in each first normal line section 51b, the electrical connection between the first portion 41 and the first normal terminal 21b is cut off, and power supply to the normal load 122 is cut. As a result, the load on the auxiliary power supply 112 is reduced, and sufficient electric power continues to be supplied to the priority load 121. Note that if a decrease in supplied power is not detected (S38: NO), the off switching of the load cutoff circuits 80d, 80e is skipped.

### Operation Pattern 3: Open Power Supply System

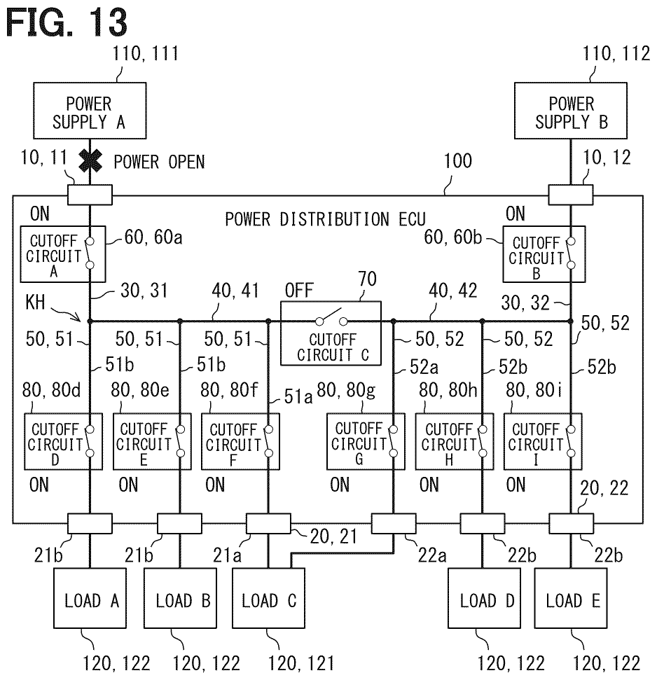

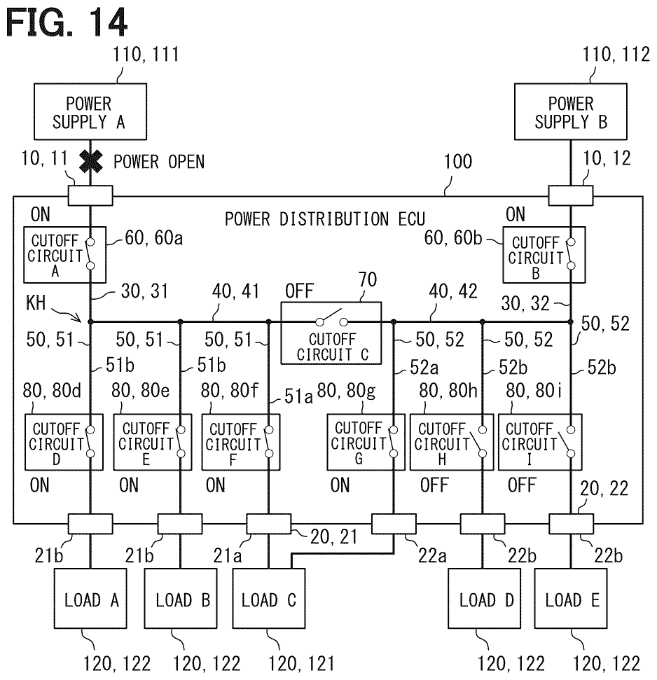

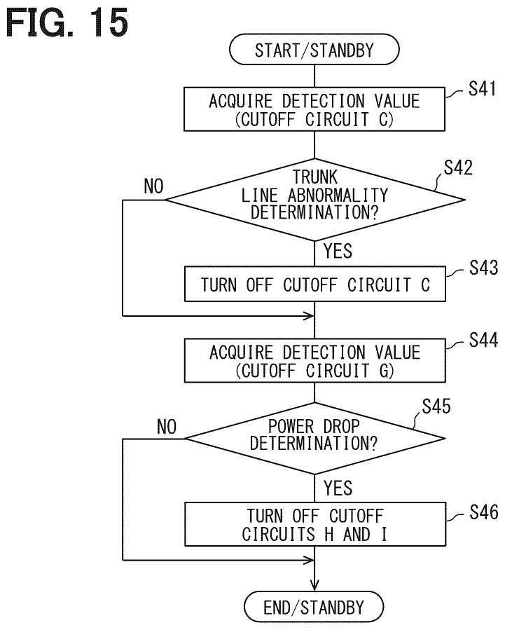

In abnormality scene 3 shown in FIGS. 13 and 14, the connection between the main power supply 111 (Power Source A) and the first power supply terminal 11 is interrupted (open), and the main power supply 111 is not operating correctly. The fault of the main power supply 111 may occur due to, for example, incorrect wiring between the first power supply terminal 11 and the main power supply 111, damage caused by an accident, a breakdown of the main power supply 111, or the like. When the main power supply 111 is not operating correctly, the power distribution ECU 100 performs a cutoff process of operation pattern 3 shown in FIG. 15. Also in the cutoff process of operation pattern 3, the first portion 41 of the power supply trunk 40 is separated from the auxiliary power supply 112 by switching off the trunk cutoff circuit 70 (Cutoff Circuit C in FIG. 13). Further, by switching off the load cutoff circuits 80h, 80i (Cutoff Circuits H, I in FIG. 14), power distribution prioritizing the priority load 121 (Load C in FIG. 14) is performed.

More specifically, in the cutoff process of operation pattern 3, the control unit 79 of the trunk cutoff circuit 70 acquires detection values of the current detection unit 76 and the voltage detection units 77a, 77b (S41). The control unit 79 compares at least one of the voltage value and the current value with a determination threshold value, and detects abnormality of the voltage value or the current value in the power supply trunk 40. After the fault of the main power supply 111, the auxiliary power supply 112 supplies electric power to all the load units 120. Therefore, the control unit 79 detects a decrease in the current value or voltage value in the power supply trunk 40 caused by insufficient power supply capacity of the auxiliary power supply 112 as abnormality (S42). Note that after the fault of the main power supply 111, off switching of the first cutoff circuit 60a (Cutoff Circuit A in FIG. 13) may be performed.

When detecting abnormality of the power supply trunk 40 (S42: YES), the control unit 79 cooperates with the drive units 78a, 78b to put the FETs 72a, 72b into a cutoff state. As a result, the trunk cutoff circuit 70 (Cutoff Circuit C in FIG. 13) is turned off (S43). According to the above, since the first portion 41 is separated from the second power supply terminal 12, the electrical connection between the second power supply terminal 12 and the first load terminal 21 is cut off. Therefore, power supply to some of the normal loads 122 (Load A, B in FIG. 13) is cut. Note that if no abnormality of the power supply trunk 40 is detected (S42: NO), the off switching of the trunk cutoff circuit 70 is skipped.

Further, when the supplied power to the priority load 121 is still insufficient even after the trunk cutoff circuit 70 is switched off, the power distribution ECU 100 interrupts the supply of electric power to another normal load 122 (Load D, E in FIG. 14). The control unit 89 of the load cutoff circuit 80g arranged in the second priority line section 52a acquires detection values of the current detection unit 86 and the voltage detection unit 87 (S44). The control unit 89 detects abnormality of the current value or the voltage value in the second priority line section 52a, that is, a decrease in supplied power to the priority load 121 (S45). When detecting a decrease in supplied power (S45: YES), the control unit 89 transmits abnormality notification signal indicating the decrease in supplied power to each control unit 89 of the load cutoff circuits 80h, 80i arranged in the second normal line section 52b.

Based on reception of the abnormality notification signal, each control unit 89 of the load cutoff circuits 80h, 80i cooperates with the drive unit 88 to put the FET 82 into a cutoff state. As a result, the load cutoff circuits 80h, 80i (Cutoff Circuits H, I in FIG. 14) are turned off (S46). According to the above, in each second normal line section 52b, the electrical connection between the second portion 42 and the second normal terminal 22b is cut off, and power supply to the normal load 122 is further cut. As a result, the load on the auxiliary power supply 112 is reduced, and sufficient electric power continues to be supplied to the priority load 121. Note that if a decrease in supplied power is not detected (S45: NO), the off switching of the load cutoff circuits 80h, 80i is skipped.

### Operation Pattern 4: Ground Fault of Load System

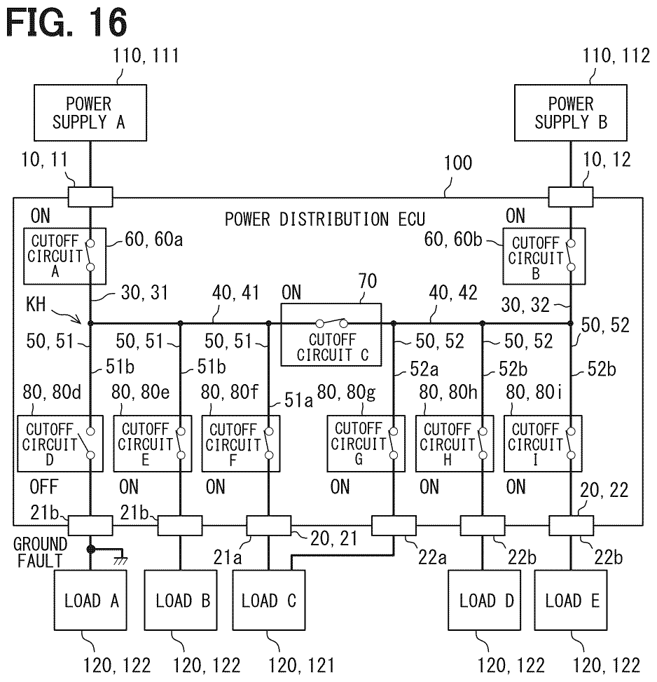

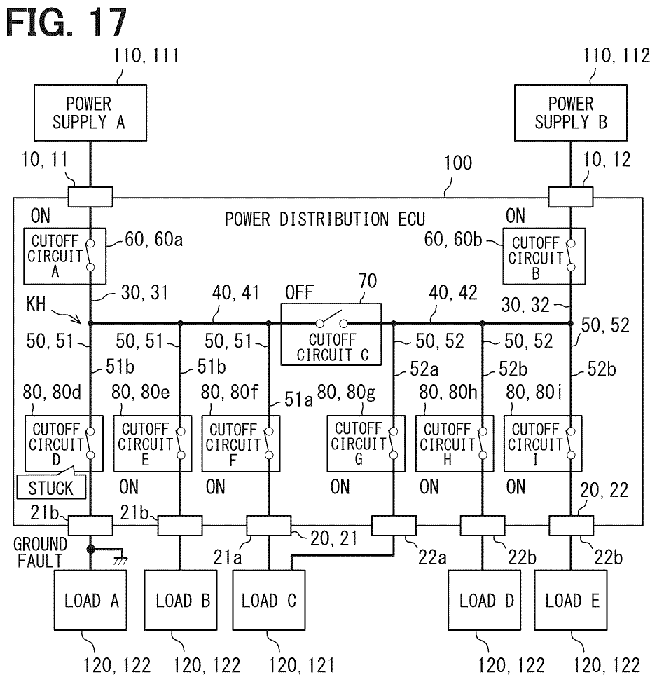

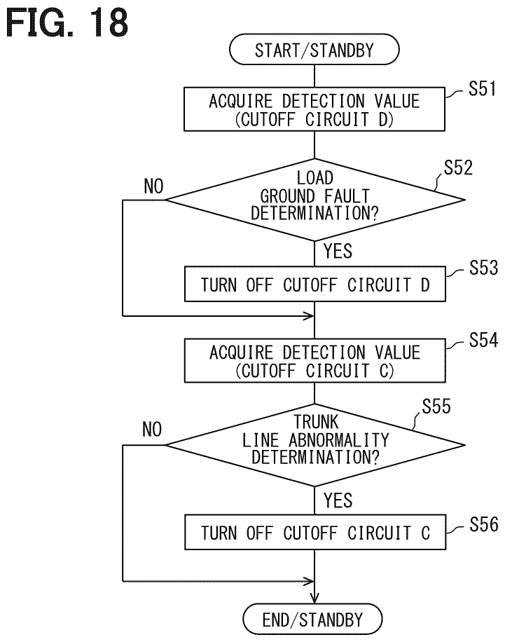

In abnormality scene 4 shown in FIGS. 16 and 17, a ground fault related to the normal load 122 (Load A) has occurred. The ground fault related to the normal load 122 may occur due to, for example, incorrect wiring between the first normal terminal 21b and the normal load 122, damage caused by an accident, a breakdown of the normal load 122, or the like. When a ground fault occurs in a path leading to the normal load 122, the power distribution ECU 100 performs a cutoff process of operation pattern 4 shown in FIG. 18. In the cutoff process of operation pattern 4, the supply of electric power to the normal load 122 having the ground fault is interrupted by switching off the load cutoff circuit 80 (Cutoff Circuit D in FIG. 16). Further, when the load cutoff circuit 80 is stuck and it is difficult to separate the normal load 122 having the ground fault, the first portion 41 is separated from the auxiliary power supply 112 by switching off the trunk cutoff circuit 70 (Cutoff Circuit C in FIG. 17).

More specifically, in the cutoff process of operation pattern 4, the control unit 89 of the load cutoff circuit 80d (Cutoff Circuit D in FIG. 16) arranged in the first normal line section 51b linked to the normal load 122 having the ground fault acquires detection values of the current detection unit 86 and the voltage detection unit 87 (S51). The control unit 69 compares at least one of the voltage value and the current value with a determination threshold value, and detects abnormality of the voltage value or the current value in the first normal line section 51b. Specifically, the control unit 89 determines that a path leading to the normal load 122 has a ground fault based on abnormality of at least one of the current value and the voltage value (S52). Specifically, as described above, when a current flows in a forward direction toward a ground fault path and the voltage value of the first normal line section 51b is an abnormal value, the control unit 89 determines that the normal load 122 has a ground fault.

When determining that the normal load 122 has a ground fault (S52: YES), the control unit 89 cooperates with the drive unit 88 to put the FET 82 into a cutoff state. As a result, the load cutoff circuit 80d is turned off (S53). According to the above, since the first normal terminal 21b is separated from the power supply trunk 40, a flow of current toward the path having the ground fault is cut off. Note that if no abnormality of the current value or the voltage value is detected (S52: NO), the off switching of the load cutoff circuit 80d is skipped.

Here, when energization cutoff of the first normal line section 51b cannot be performed due to stuck of the load cutoff circuit 80d, the control unit 79 of the trunk cutoff circuit 70 receives abnormality notification signal indicating occurrence of sticking from the control unit 89 of the load cutoff circuit 80d having the stuck fault. In addition, the control unit 79 acquires detection values of the current detection unit 76 and the voltage detection units 77a, 77b (S54). The control unit 79 compares at least one of the voltage value and the current value with a determination threshold value, and detects occurrence of abnormality in the power supply trunk 40 (S55).

When grasping the stuck fault of the load cutoff circuit 80d and determining that abnormality has occurred in the power supply trunk 40 (S55: YES), the control unit 79 cooperates with the drive units 78a, 78b to put the FETs 72a, 72b into a cutoff state. As a result, the trunk cutoff circuit 70 (Cutoff Circuit C in FIG. 17) is turned off (S56). According to the above, since the first portion 41 is separated from the second power supply terminal 12, the electrical connection between the second power supply terminal 12 and the first load terminal 21 is cut off. As a result, power supply to the normal load 122 related to the ground fault is at least cut, and sufficient electric power can be supplied to the priority load 121. Note that if no abnormality of the current value or the voltage value is detected (S55: NO), the off switching of the trunk cutoff circuit 70 is skipped.

### Operation Pattern 5: Ground Fault of Auxiliary Power Supply System and Voltage Drop of Main Power Supply Due to Ground Fault

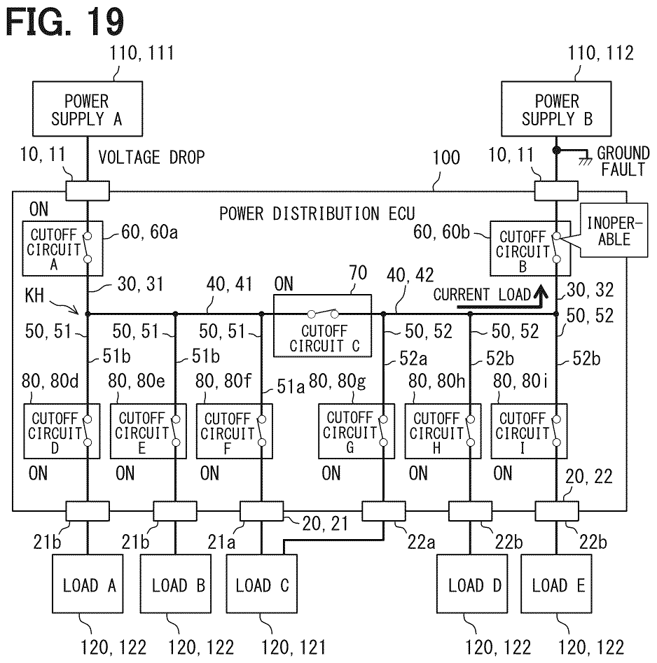

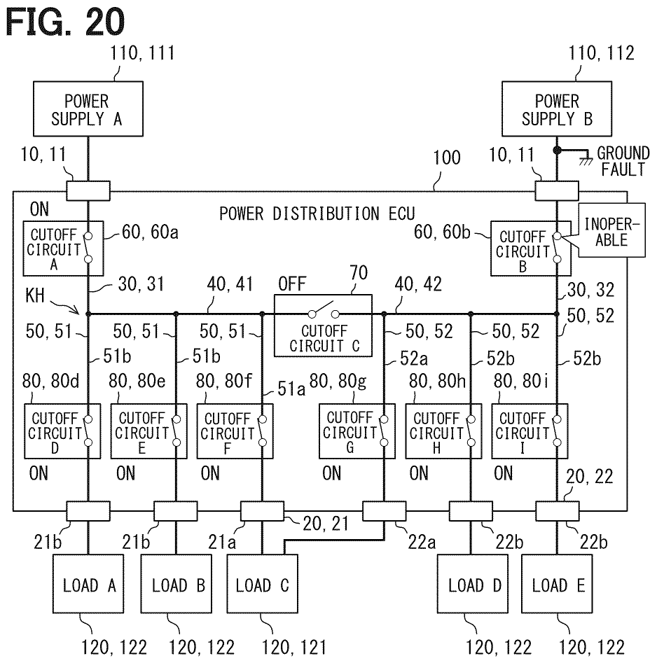

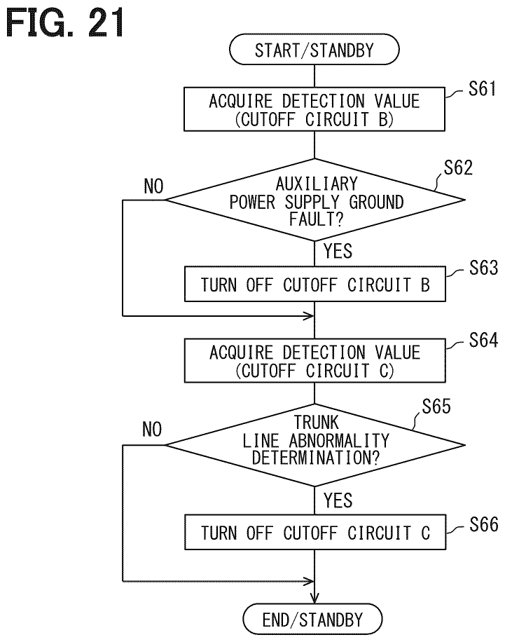

In abnormality scene 5 shown in FIGS. 19 and 20, a ground fault related to the auxiliary power supply 112 (Power Source B) has occurred. The ground fault of the auxiliary power supply 112 may occur due to, for example, incorrect wiring between the second power supply terminal 12 and the auxiliary power supply 112, damage caused by an accident, or the like. When the auxiliary power supply 112 has a ground fault, the power distribution ECU 100 performs a cutoff process of operation pattern 5 shown in FIG. 21. In the cutoff process of operation pattern 5, the auxiliary power supply 112 is separated from the power supply trunk 40 by switching off the second cutoff circuit 60b (Cutoff Circuit B in FIG. 19). Further, when the second cutoff circuit 60b does not operate normally, the second portion 42 is separated from the main power supply 111 by switching off the trunk cutoff circuit 70 (Cutoff Circuit C in FIG. 20).

More specifically, in the cutoff process of operation pattern 5, the control unit 69 of the second cutoff circuit 60b acquires detection values of the current detection unit 66 and the voltage detection unit 67 (S61). The control unit 69 compares at least one of the voltage value and the current value with a determination threshold value, and detects abnormality of the current value or the voltage value in the second power supply line section 32. The control unit 69 determines that the auxiliary power supply 112 has a ground fault based on abnormality of at least one of the current value and the voltage value (S62). Specifically, as described above, when a current flows in a reverse direction toward a ground fault path and the voltage value of the second power supply line section 32 is an abnormal value, the control unit 69 determines that the auxiliary power supply 112 has a ground fault.

When determining that the auxiliary power supply 112 has a ground fault (S62: YES), the control unit 69 cooperates with the drive unit 68 to put the FET 62 into a cutoff state. As a result, the second cutoff circuit 60b is turned off (S63). According to the above, the electrical connection between the second portion 42 and the second power supply terminal 12 is cut off, and an increase in current load from the second portion 42 toward the auxiliary power supply 112 is suppressed. Note that if it is not determined that the auxiliary power supply 112 has a ground fault (S62: NO), the off switching of the second cutoff circuit 60b is skipped.

Here, a case may occur in which the second cutoff circuit 60b (Cutoff Circuit B in FIG. 20) becomes inoperable due to a decrease in output voltage of the main power supply 111 because a response of the main power supply 111 is not in time. In this case, the control unit 79 of the trunk cutoff circuit 70 acquires detection values of the current detection unit 76 and the voltage detection units 77a, 77b (S64). The control unit 79 compares at least one of the voltage value and the current value with a determination threshold value, and detects occurrence of abnormality in the power supply trunk 40 (S65). The control unit 79 detects, for example, an increase in current load on the power supply trunk 40 based on the acquired current value.

When detecting abnormality of the power supply trunk 40 (S65: YES), the control unit 79 cooperates with the drive units 78a, 78b to put the FETs 72a, 72b into a cutoff state. As a result, the trunk cutoff circuit 70 (Cutoff Circuit C in FIG. 20) is turned off (S66). According to the above, since the second portion 42 is separated from the first portion 41, the electrical connection between the first power supply terminal 11 and the second load terminal 22 is cut off. As a result, power supply to the normal load 122 (Load H, I in FIG. 20) is cut, and sufficient electric power can be supplied to the load unit 120 (Load A to C in FIG. 20) connected to the first portion 41. Note that if no abnormality of the current value or the voltage value is detected (S65: NO), the off switching of the trunk cutoff circuit 70 is skipped.

### Operation Pattern 6: Increase in Consumption Current in Load System

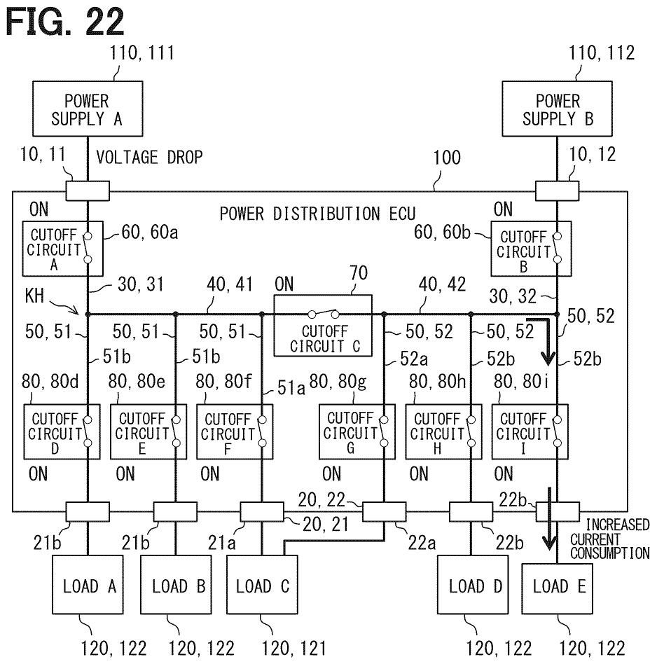

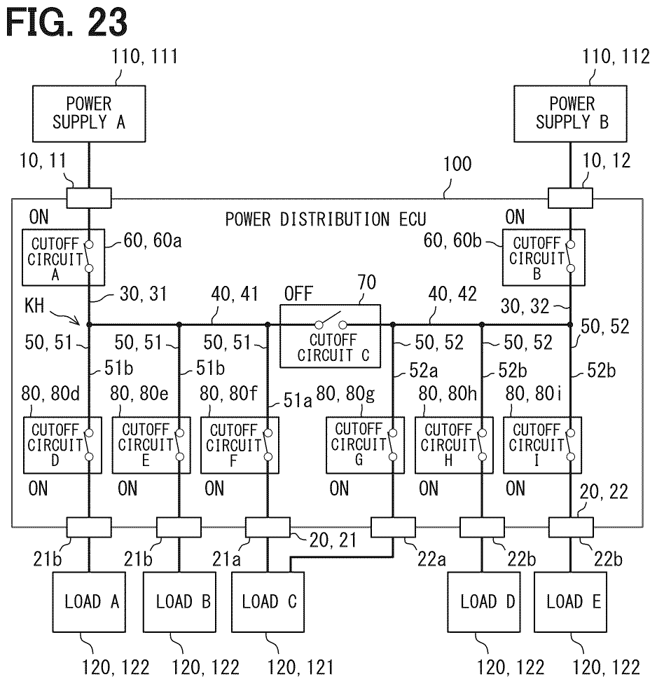

In abnormality scene 6 shown in FIGS. 22 and 23, a consumption current of the normal load 122 (Cutoff Circuit E) connected to the second normal terminal 22b is increasing. In this case, the power distribution ECU 100 performs a cutoff process of operation pattern 6 shown in FIG. 24. In the cutoff process of operation pattern 6, the electrical connection between the main power supply 111 (first power supply terminal 11) and the second portion 42 is cut off by switching off the trunk cutoff circuit 70 (Cutoff Circuit C in FIG. 23). Note that the cutoff process of operation pattern 6 may be similarly performed even when a consumption current of another normal load 122 (Cutoff Circuits A, B, D in FIG. 22) increases.

More specifically, in the cutoff process of operation pattern 6, the control unit 89 of the load cutoff circuit 80i acquires detection values of the current detection unit 86 and the voltage detection unit 87 (S71). The control unit 89 compares at least one of the voltage value and the current value with a determination threshold value, and detects abnormality of the detection value in the second normal line section 52b (S72). The control unit 89 detects, for example, an increase in consumption current flowing through the second normal line section 52b based on the acquired current value.

When detecting an increase in consumption current in the second normal line section 52b (S72: YES), the control unit 89 transmits abnormality notification signal indicating the increase in consumption current to the control unit 79 of the trunk cutoff circuit 70. Based on reception of the abnormality notification signal, the control unit 79 cooperates with the drive units 78a, 78b to put the FETs 72a, 72b into a cutoff state. As a result, the trunk cutoff circuit 70 (Cutoff Circuit C in FIG. 23) is turned off (S73). According to the above, power supply to the normal load 122 (Load D, E in FIG. 23) connected to the second normal terminal 22b is cut. Note that if an increase in consumption current is not detected (S72: NO), the off switching of the trunk cutoff circuit 70 is skipped.

### Operation Pattern 7: Protection of Auxiliary Power Supply From Overvoltage

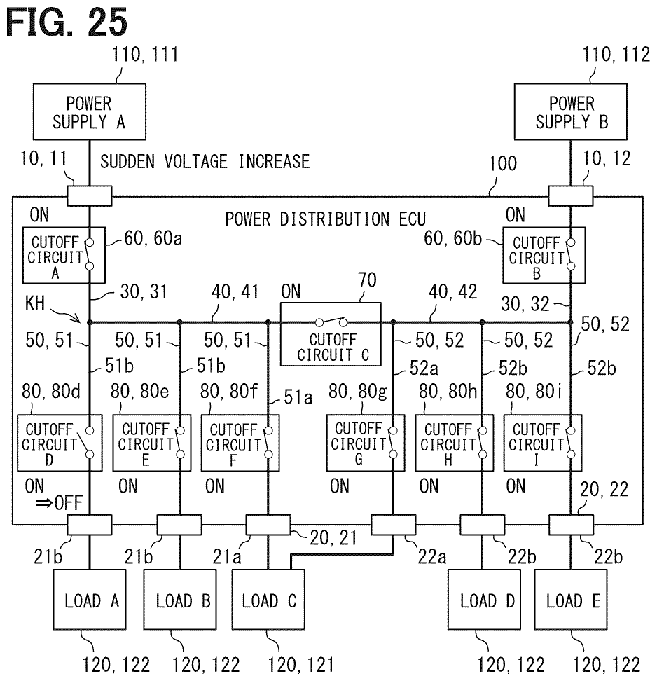

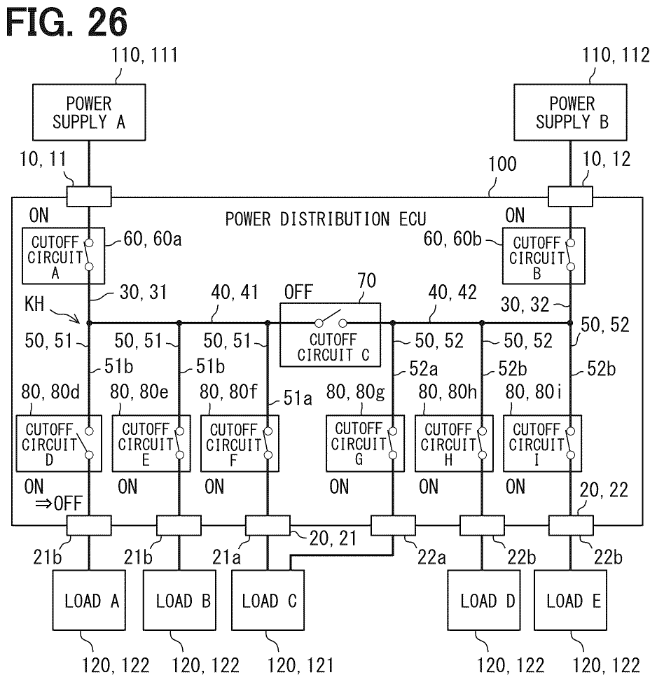

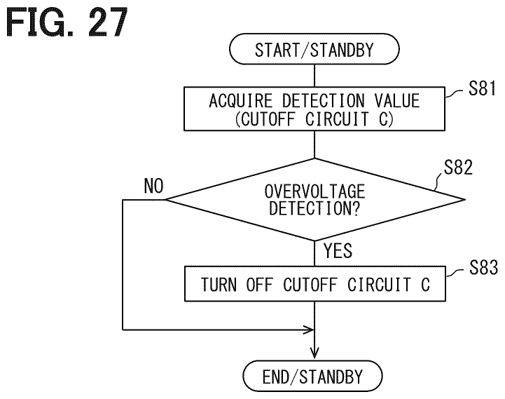

In abnormality scene 7 shown in FIGS. 25 and 26, normal off switching is performed in the load cutoff circuit 80d (Cutoff Circuit D) of the first normal line section 51b connected to the first portion 41. At this time, since the current supplied by the main power supply 111 decreases rapidly, the output voltage of the main power supply 111 may rise rapidly. The rapid rise in the output voltage of the main power supply 111 may cause application of an overvoltage to the auxiliary power supply 112, and eventually a breakdown of the auxiliary power supply 112. To avoid such a situation, the power distribution ECU 100 performs a cutoff process of operation pattern 7 shown in FIG. 27. In the cutoff process of operation pattern 7, application of an overvoltage to the auxiliary power supply 112 is prevented by switching off the trunk cutoff circuit 70 (Cutoff Circuit C in FIG. 26).

More specifically, in the cutoff process of operation pattern 7, the control unit 79 of the trunk cutoff circuit 70 acquires detection values of the current detection unit 76 and the voltage detection units 77a, 77b (S81). The control unit 79 compares at least one of the voltage value and the current value with a determination threshold value, and detects abnormality of the detection value in the power supply trunk 40 (S82). In this case, the control unit 79 detects occurrence of an overvoltage on the first portion 41 side based on the voltage value acquired from the voltage detection unit 77a.

When detecting occurrence of an overvoltage on the first portion 41 side (S82: YES), the control unit 79 cooperates with the drive units 78a, 78b to put the FETs 72a, 72b into a cutoff state. As a result, the trunk cutoff circuit 70 (Cutoff Circuit C in FIG. 26) is turned off (S83). As a result, since the second power supply terminal 12 is separated from the first portion 41, application of an overvoltage to the auxiliary power supply 112 can be prevented. Note that if occurrence of an overvoltage is not detected (S82: NO), the off switching of the trunk cutoff circuit 70 is skipped.

### Operation Pattern 8: Ground Fault of Power Supply Wiring

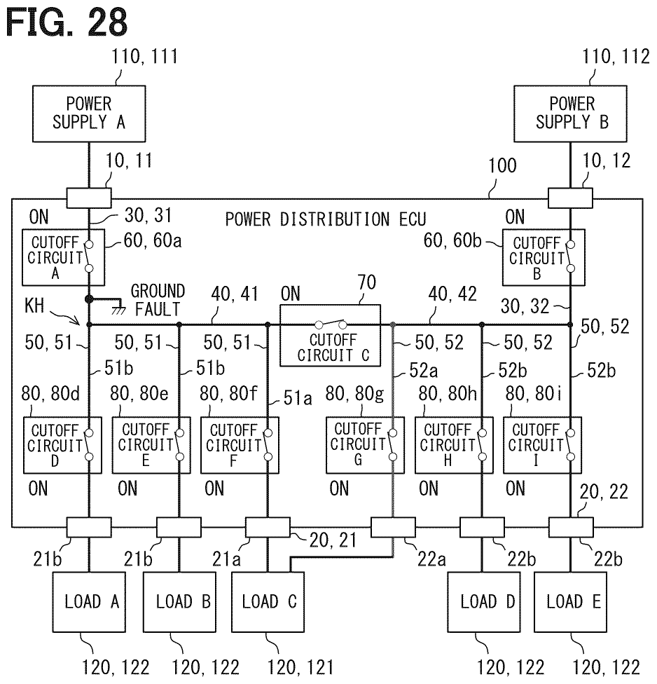

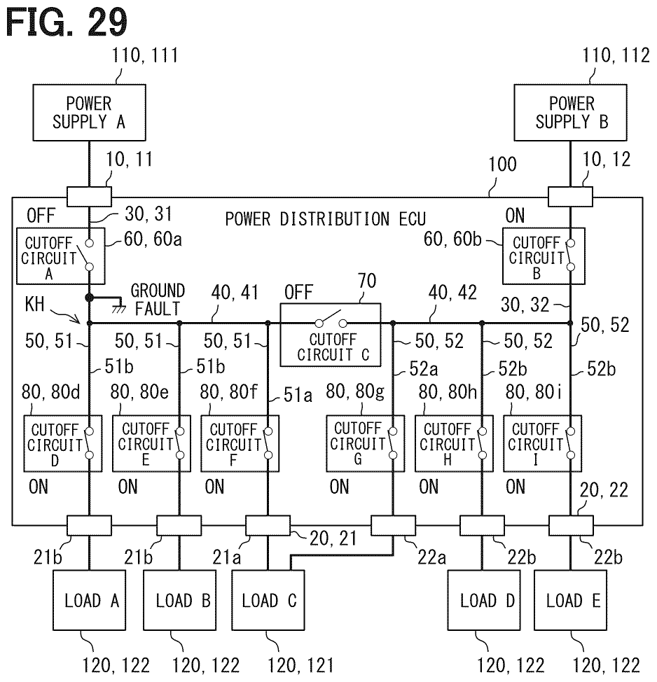

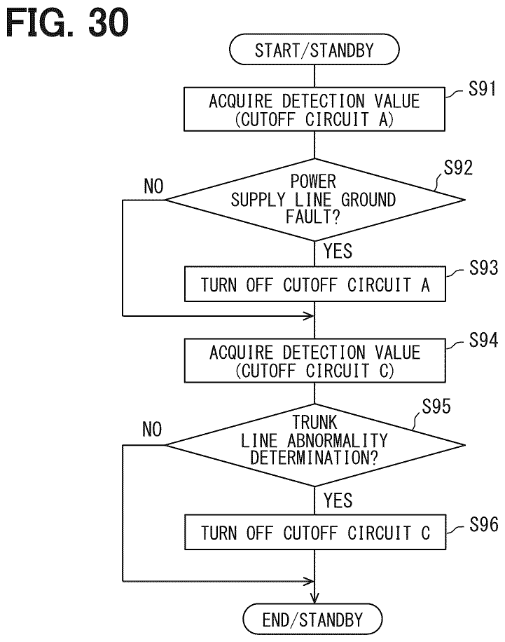

In abnormality scene 8 shown in FIGS. 28 and 29, a ground fault has occurred in the power feeding wiring KH in the power distribution ECU 100. Abnormality of the power feeding wiring KH may occur due to damage caused by an accident or the like, a breakdown of the printed wiring board, or the like. In such abnormality scene 8, since a large current flows through a ground fault path, the voltage of the power supply trunk 40 decreases, and power supply to the priority load 121 may become insufficient. As an example, when a ground fault occurs in the first power supply line section 31 which is on the power supply trunk 40 side relative to the first cutoff circuit 60a (Cutoff Circuit A), the power distribution ECU 100 performs a cutoff process of operation pattern 8 shown in FIG. 30. In the cutoff process of operation pattern 8, the main power supply 111 is electrically separated from the first power supply line section 31 by switching off the first cutoff circuit 60a (Cutoff Circuit A in FIG. 29). Further, the first portion 41 connected to the ground fault path is separated from the second portion 42 by switching off the trunk cutoff circuit 70 (Cutoff Circuit C in FIG. 29).

More specifically, in the cutoff process of operation pattern 8, the control unit 69 of the first cutoff circuit 60a acquires detection values of the current detection unit 66 and the voltage detection unit 67 (S91). The control unit 69 compares at least one of the voltage value and the current value with a determination threshold value, and determines whether or not the first power supply line section 31 on the power supply trunk 40 side has a ground fault (S92). When determining that the first power supply line section 31 has a ground fault (S92: YES), the control unit 69 cooperates with the drive unit 68 to put the FET 62 into a cutoff state. As a result, the first cutoff circuit 60a (Cutoff Circuit A in FIG. 29) is turned off (S93). As a result, a situation in which a large current flows through the ground fault path of the first power supply line section 31 can be prevented. Note that if it is determined that the first power supply line section 31 does not have a ground fault (S92: NO), the off switching of the first cutoff circuit 60a is skipped.

Further, the control unit 79 of the trunk cutoff circuit 70 acquires detection values of the current detection unit 76 and the voltage detection units 77a, 77b (S94). The control unit 79 compares at least one of the voltage value and the current value with a determination threshold value, and determines whether or not a ground fault has occurred on the first portion 41 side (S95). When determining that a ground fault has occurred on the first portion 41 side (S95: YES), the control unit 79 cooperates with the drive units 78a, 78b to put the FETs 72a, 72b into a cutoff state. As a result, the trunk cutoff circuit 70 (Cutoff Circuit C in FIG. 29) is turned off (S96). According to the above, since the first portion 41 and the second portion 42 are separated, a voltage drop in the second portion 42 is suppressed. As a result, power supply to the priority load 121 and the normal load 122 connected to the second load terminal 22 can be continued. Note that if it is determined that no ground fault has occurred on the first portion 41 side (S95: NO), the off switching of the trunk cutoff circuit 70 is skipped.

### Summary of Embodiment

In the present embodiment described so far, the electrical connection between the first power supply line section 31 and the second power supply line section 32 is cut off by the trunk cutoff circuit 70 based on abnormality of at least one of the current value and the voltage value, and the first power supply line section 31 and the second power supply line section 32 can be electrically separated. According to the above, even when abnormality occurs in a circuit related to the power distribution ECU 100, it becomes possible to appropriately perform power supply from the power supply units 110 to the load terminals 20, and eventually power supply to the load unit 120 connected to each load terminal 20.

More specifically, by providing the power supply cutoff circuit 60 on the power supply trunk 40 connecting between the power supply terminals 10, the power distribution ECU 100 can appropriately supply power to the load units 120 even when abnormality occurs in a part of the power feeding wiring KH. Specifically, by switching between the on state and the off state of the power supply cutoff circuit 60, the power distribution ECU 100 can receive power supply from the power supply units 110 and appropriately distribute power to the load units 120. According to the above, the power distribution ECU 100 can acquire redundancy such that power supply to each load unit 120 can be correctly performed even when abnormality occurs in the power supply system or the load system.

In addition, in the present embodiment, the power supply trunk 40 is electrically connected to both the first power supply line section 31 and the second power supply line section 32. The trunk cutoff circuit 70 includes the switch unit 71 that switches between energization and energization cutoff between the first power supply line section 31 and the second power supply line section 32 in the power supply trunk 40. According to the above configuration, the trunk cutoff circuit 70 can quickly cut off energization between the first power supply line section 31 and the second power supply line section 32 by the operation of the switch unit 71. As a result, the power distribution ECU 100 can control the distribution of electric power to the load unit 120 more smoothly when abnormality occurs.

Further, in the present embodiment, the first load terminal 21 electrically connected to the first power supply line section 31 and the second load terminal 22 electrically connected to the second power supply line section 32 are included in the load terminals 20. According to such a configuration, even when abnormality occurs in one of the power supply units 110, power supply to at least one of the first load terminal 21 and the second load terminal 22 can be continued.

Furthermore, the first power supply terminal 11 of the present embodiment is electrically connected to the second load terminal 22 in a state where the trunk cutoff circuit 70 does not cut off the electrical connection between the first power supply line section 31 and the second power supply line section 32. On the other hand, in a state where the trunk cutoff circuit 70 cuts off the electrical connection between the first power supply line section 31 and the second power supply line section 32, the first power supply terminal 11 is electrically cut off from the second load terminal 22. Further, the second power supply terminal 12 is electrically connected to the first load terminal 21 in a state where the trunk cutoff circuit 70 does not cut off the electrical connection between the first power supply line section 31 and the second power supply line section 32. On the other hand, in a state where the trunk cutoff circuit 70 cuts off the electrical connection between the first power supply line section 31 and the second power supply line section 32, the second power supply terminal 12 is electrically cut off from the first load terminal 21. As described above, according to energization cutoff by the trunk cutoff circuit 70, it becomes possible to electrically separate the second load terminal 22 and the first load terminal 21 from the first power supply terminal 11 and the second power supply terminal 12. As a result, even when abnormality occurs in the power supply system or the load system, the power distribution ECU 100 can continue power supply to some of the load terminals 20.

In addition, in the present embodiment, at least one of the first power supply line section 31 and the second power supply line section 32 is provided with the power supply cutoff circuit 60 that cuts off the electrical connection between the power supply terminal 10 and the load terminal 20. In this way, if the power supply cutoff circuit 60 different from the trunk cutoff circuit 70 is provided in the power feeding wiring KH, energization cutoff by the power supply cutoff circuit 60 becomes possible even when an operation fault occurs in the trunk cutoff circuit 70. As a result, the power distribution ECU 100 can more reliably continue appropriate power supply to the load unit 120.

Further, the power supply cutoff circuit 60 of the present embodiment cuts off the electrical connection between the power supply terminal 10 and the load terminal 20 based on abnormality of at least one of the current value and the voltage value caused by a ground fault related to the power supply unit 110. According to the above, by performing energization cutoff of the power supply cutoff circuit 60, the power distribution ECU 100 can electrically separate the power supply unit 110 related to the ground fault from the power feeding wiring KH. As a result, power feeding from the normal power supply unit 110 to the load unit 120 can be continued.

Furthermore, the first load line section 51 of the present embodiment electrically connects the first load terminal 21 to the first portion 41 which is on the first power supply line section 31 side relative to the trunk cutoff circuit 70 in the power supply trunk 40. Also, the second load line section 52 electrically connects the second load terminal 22 to the second portion 42 which is on the second power supply line section 32 side relative to the trunk cutoff circuit 70 in the power supply trunk 40. According to the above configuration, the first load terminal 21 and the second load terminal 22 are electrically separated by energization cutoff of the power supply trunk 40 by the trunk cutoff circuit 70. As a result, even when abnormality occurs, the power distribution ECU 100 can continue power feeding from the normal power supply unit 110 to the normal load unit 120.

In addition, in the present embodiment, at least one of the first load line section 51 and the second load line section 52 is provided with the load cutoff circuit 80 that cuts off the electrical connection between the power supply trunk 40 and the load terminal 20. In this way, if the load cutoff circuit 80 different from the trunk cutoff circuit 70 is provided in the power feeding wiring KH, energization cutoff by the load cutoff circuit 80 becomes possible even when an operation fault occurs in the trunk cutoff circuit 70. As a result, the power distribution ECU 100 can more reliably continue appropriate power supply to the load unit 120.

Further, the load cutoff circuit 80 of the present embodiment cuts off the electrical connection between the power supply terminal 10 and the load terminal 20 based on abnormality of at least one of the current value and the voltage value caused by a ground fault related to the load unit 120. According to the above, by performing energization cutoff of the load cutoff circuit 80, the power distribution ECU 100 can electrically separate the load unit 120 related to the ground fault from the power feeding wiring KH. As a result, power feeding to another normal load unit 120 can be continued.

Also, in the present embodiment, at least one of the first load terminals 21 and at least one of the second load terminals 22 are the first priority terminal 21a and the second priority terminal 22a. The first priority terminal 21a and the second priority terminal 22a are electrically connected to the same priority load 121, of which power supply is prioritized over the other normal load 122 among the load units 120. According to the above configuration, even when abnormality occurs in the power supply system or the load system and the trunk cutoff circuit 70 performs energization cutoff of the power supply trunk 40, power supply to the priority load 121 can be continued.

Furthermore, the first priority terminal 21a and the second priority terminal 22a of the present embodiment are electrically connected to the priority load 121 requiring redundancy. Therefore, the power distribution ECU 100 can continue power supply to the priority load 121 requiring redundancy even when abnormality occurs in the power supply system or the load system.

In addition, in the present embodiment, the first priority terminal 21a and the second priority terminal 22a are adjacent to each other. Therefore, even with a structure in which terminals are connected to one priority load 121, work for connection can be smoothly performed in a connection process between the power distribution ECU 100 and the priority load 121.

Furthermore, in the present embodiment, the first priority terminal 21a and the second priority terminal 22a are electrically connected to the priority load 121, of which power supply is prioritized among the load units 120. Also, the first normal terminal 21b and the second normal terminal 22b are electrically connected to the normal load 122 other than the priority load 121. In addition, the first priority line section 51a and the second priority line section 52a electrically connect the first priority terminal 21a and the second priority terminal 22a to the power supply trunk 40. Similarly, the first normal line section 51b and the second normal line section 52b electrically connect the first normal terminal 21b and the second normal terminal 22b to the power supply trunk 40. The load cutoff circuits 80d, 80e, 80h, 80i cut off the electrical connection between the power supply trunk 40 and the first normal terminal 21b and the second normal terminal 22b based on abnormality of the current value or the voltage value in the first priority line section 51a or the second priority line section 52a. According to the above, in the abnormality scenes 1 to 3 or the like where electric power supplied to the power distribution ECU 100 is insufficient, it becomes possible to prioritize power supply to the priority load 121 having high priority over the other normal load 122.

In addition, electric power is supplied from the main power supply 111 to the first power supply terminal 11 of the present embodiment. On the other hand, electric power is supplied to the second power supply terminal 12 from the auxiliary power supply 112 having a lower power supply capacity than the main power supply 111. As described above, even when there is a difference in power supply capacity between the power supply units 110 connected to the respective power supply terminals 10, the power distribution ECU 100 can appropriately control power distribution to each load unit 120.

Also, the second priority line section 52a of the present embodiment electrically connects the second priority terminal 22a to the second portion 42 of the power supply trunk 40. In addition, the second normal line section 52b electrically connects the second normal terminal 22b to the second portion 42. In a state where the trunk cutoff circuit 70 cuts off energization of the power supply trunk 40, the load cutoff circuits 80h, 80i cut off the electrical connection between the power supply trunk 40 and the second normal terminal 22b by the second normal line section 52b based on abnormality of the current value or the voltage value in the second priority line section 52a. According to the above, in the abnormality scenes 1, 3 or the like where electric power is insufficient even if energization of the power supply trunk 40 is cut off by the trunk cutoff circuit 70, it becomes possible to prioritize power supply to the priority load 121 having high priority over the other normal load 122.

Furthermore, the first priority line section 51a of the present embodiment electrically connects the first priority terminal 21a to the first portion 41 of the power supply trunk 40. In addition, the first normal line section 51b electrically connects the first normal terminal 21b to the first portion 41. In a state where the trunk cutoff circuit 70 cannot cut off energization of the power supply trunk 40, the load cutoff circuits 80d, 80e cut off the electrical connection between the power supply trunk 40 and the first normal terminal 21b by the first normal line section 51b based on abnormality of the voltage value or the current value in the first priority line section 51a. According to the above, even in the abnormality scene 2 or the like where the trunk cutoff circuit 70 has a stuck fault and energization cutoff of the power supply trunk 40 cannot be performed, it becomes possible to prioritize power supply to the priority load 121 having high priority over the other normal load 122.

In addition, the trunk cutoff circuit 70 of the present embodiment includes an electric fuse EF. The trunk cutoff circuit 70 having such a configuration can repeatedly switch between energization and energization cutoff. That is, switching from the off state to the on state can be performed without replacing parts or the like. As a result, the power distribution ECU 100 can quickly perform on switching of the trunk cutoff circuit 70 and restart power feeding to each load unit 120.

Further, the trunk cutoff circuit 70 of the present embodiment cuts off both the current flowing from the first power supply line section 31 toward the second power supply line section 32 and the current flowing from the second power supply line section 32 toward the first power supply line section 31. Therefore, when abnormality occurs in a circuit related to the power distribution ECU 100, the trunk cutoff circuit 70 can reliably separate the first portion 41 and the second portion 42.

Furthermore, the power supply cutoff circuit 60 of the present embodiment cuts off the current in the reverse direction among the current in the forward direction flowing from the power supply terminal 10 toward the load terminal 20 and the current in the reverse direction flowing from the load terminal 20 toward the power supply terminal 10. That is, the power supply cutoff circuit 60 does not completely cut off the current in the forward direction. With such a configuration, the power supply cutoff circuit 60 can reliably cut off the current toward the ground fault path in the abnormality scene 1 (see FIG. 7) where a ground fault or the like occurs in a connection line with the main power supply 111 while maintaining a simple structure.

In addition, the load cutoff circuit 80 of the present embodiment cuts off the current in the forward direction among the current in the forward direction flowing from the power supply trunk 40 toward the load terminal 20 and the current in the reverse direction flowing from the load terminal 20 toward the power supply trunk 40. That is, the load cutoff circuit 80 does not completely cut off the current in the reverse direction. With such a configuration, the load cutoff circuit 80 can reliably cut off the current toward the ground fault path in the abnormality scene 4 (see FIG. 17) where a ground fault or the like occurs in a connection line with the load unit 120 while maintaining a simple structure.

In the above embodiment, the power supply terminal 10 corresponds to a “power supply terminal unit”, the load terminal 20 corresponds to a “load terminal unit”, and the first priority terminal 21a and the second priority terminal 22a correspond to a “priority terminal”. The first normal terminal 21b and the second normal terminal 22b correspond to a “normal terminal”. Also, the power supply trunk 40 corresponds to a “power supply trunk section”, the first portion 41 corresponds to a “main portion”, and the second portion 42 corresponds to an “auxiliary portion”. Furthermore, the first priority line section 51a and the second priority line section 52a correspond to a “priority supply line section”, the first normal line section 51b and the second normal line section 52b correspond to a “normal supply line section”, and the power distribution ECU 100 corresponds to a “vehicle control device”.

### Other Embodiments

Although one embodiment according to the present disclosure has been described above, the present disclosure should not be interpreted as being limited to the above embodiment, and can be applied to various embodiments and combinations without departing from the gist of the present disclosure.

In Modification 1 of the above embodiment, the power supply cutoff circuit 60 capable of cutting off bidirectional currents is used. That is, the power supply cutoff circuit 60 may have the same circuit configuration as the trunk cutoff circuit 70 shown in FIG. 3. The power supply cutoff circuit 60 cuts off both a current in a forward direction flowing from the power supply terminal 10 toward the load terminal 20 and a current in a reverse direction flowing from the load terminal 20 toward the power supply terminal 10. Therefore, even in abnormality scene where a ground fault or the like occurs in the connection line with the main power supply 111, or abnormality scene where a ground fault occurs in the power supply wiring 30 on the power supply trunk 40 side, the power supply cutoff circuit 60 can reliably cut off the current toward the ground fault path.

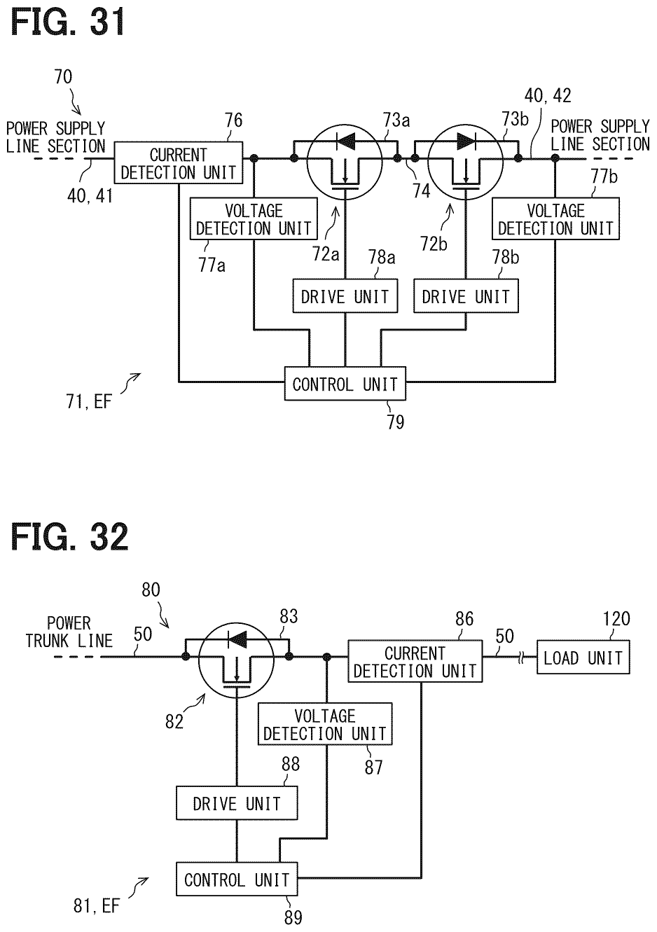

In Modification 2 of the above embodiment, the trunk cutoff circuit 70 shown in FIG. 31 is used. In the trunk cutoff circuit 70, the current detection unit 76 is provided in the first portion 41 which is on the first power supply line section 31 side relative to the voltage detection unit 77a. The current detection unit 76 detects the current value and the current direction of the first portion 41. As in Modification 2 described above, the circuit configuration of the trunk cutoff circuit 70 may be changed as appropriate. For example, the current detection unit 76 may be provided in the second portion 42 which is on the second power supply line section 32 side relative to the voltage detection unit 77b.

In Modification 3 of the above embodiment, the load cutoff circuit 80 shown in FIG. 32 is used. In the load cutoff circuit 80, the current detection unit 86 is provided in the load wiring 50 which is on the load unit 120 side relative to the voltage detection unit 87. The current detection unit 76 detects the current value and the current direction between the FET 82 and the load terminal 20. As in Modification 3 described above, the circuit configuration of the load cutoff circuit 80 may be changed as appropriate.

Further, the power supply cutoff circuit 60 may have the same circuit configuration as the trunk cutoff circuit 70 shown in FIG. 31. Furthermore, the power supply cutoff circuit 60 may have the same circuit configuration as the load cutoff circuit 80 shown in FIG. 32, and may be capable of cutting off a current in a reverse direction.

In the trunk cutoff circuit 70 according to Modification 4 of the above embodiment, the current detection unit 76 is provided, while the voltage detection unit 77 is not provided. The control unit 79 performs off switching of the FET 72 based on the current value detected by the current detection unit 76. Also, in the trunk cutoff circuit 70 according to Modification 5, the voltage detection unit 77 is provided, while the current detection unit 76 is not provided. The control unit 79 performs off switching of the FET 72 based on the voltage value detected by the voltage detection unit 77. As in Modifications 4 and 5 described above, the detection value used for detecting abnormality in the trunk cutoff circuit 70 may be only one of the current value and the voltage value. Furthermore, the detection value used for detecting abnormality in the power supply cutoff circuit 60 and the load cutoff circuit 80 may also be only one of the current value and the voltage value.

In the above embodiment, the control unit is individually provided for each cutoff circuit. On the other hand, the power distribution ECU 100 of Modification 6 of the above embodiment includes an integrated control unit in which at least a part of the control units 69, 79, 89 are integrated. The integrated control unit controls on and off switching of FETs of the cutoff circuits. Also, in Modification 7 of the above embodiment, an integrated control unit is provided separately from the control unit of each cutoff circuit. The integrated control unit can cooperate with the control unit of each cutoff circuit to coordinate switching between energization and energization cutoff of the cutoff circuits. As in Modifications 6 and 7 described above, the configuration of the control unit of the power distribution ECU 100 may be changed as appropriate.

Furthermore, the control unit and the integrated control unit may be configured by a microcontroller mainly including a CPU (Central Processing Unit), or may be configured by a hardware circuit such as a discrete circuit. Furthermore, the functions of the control unit and the integrated control unit may be provided by an SoC, an ASIC, an FPGA, or the like. The SoC is a System on Chip, and the ASIC is an Application Specific Integrated Circuit. Also, the FPGA is a Field-Programmable Gate Array.

In Modification 8 of the above embodiment, the priority load 121 and the normal load 122 are not distinguished. Also, the priority load 121 of Modification 9 of the above embodiment is connected to only one of the first load terminal 21 and the second load terminal 22. In addition, the normal load 122 of Modification 10 of the above embodiment is electrically connected to both the first load terminal 21 and the second load terminal 22. Furthermore, assuming a fault of the load cutoff circuit 80, the load unit 120 may be electrically connected to two first load terminals 21 or two second load terminals 22.

A vehicle on which the power distribution ECU 100 according to the present disclosure is mounted is not limited to a POV (Personally Owned Vehicle) assuming general personal ownership. The power distribution ECU 100 may be mounted on a rental car vehicle, a manned taxi vehicle, a ride-share vehicle, a freight vehicle, a bus, and the like. Furthermore, the power distribution ECU 100 may be mounted on an unmanned driving vehicle, a construction machine, an agricultural machine, a railway vehicle, a tram, a DMV (Dual Mode Vehicle), and the like used for mobility services. Also, the power distribution ECU 100 may be mounted on a ship and an electric aircraft such as a drone and an eVTOL as a mobility control device.

In the present disclosure, the description “connected” may mean directly connected to another element, or may mean indirectly connected via an intervening element. Also, the description “adjacent” may mean directly side-by-side with another element without an intervening element, or may mean indirectly side-by-side via an intervening element.

The control unit and the method thereof described in the present disclosure may be realized by a dedicated computer constituting a processor programmed to execute one or functions embodied by a computer program. Alternatively, the device and the method thereof described in the present disclosure may be realized by a dedicated hardware logic circuit. Alternatively, the device and the method thereof described in the present disclosure may be realized by one or more dedicated computers configured by a combination of a processor executing a computer program and one or more hardware logic circuits. Also, the computer program may be stored in a computer-readable non-transitory tangible recording medium as instructions executed by a computer.

What is claimed is:

1. A vehicle control device configured to control distribution of electric power supplied from power supply units to load units in a vehicle, the vehicle control device comprising:
power supply terminal units configured to be electrically connected to the power supply units, the power supply terminal units including (i) a first power supply terminal configured to receive electric power supplied from a main power supply and (ii) a second power supply terminal configured to receive electric power supplied from an auxiliary power supply having a lower power supply capacity than the main power supply;
load terminal units configured to be electrically connected to the load units, the load units including a priority load and a normal load, the priority load having priority over the normal load in receiving electric power, the load terminal units including (i) a priority terminal configured to be electrically connected to the priority load and (ii) a normal terminal configured to be electrically connected to the normal load;
a first power supply line section configured to be electrically connected to the first power supply terminal;
a second power supply line section configured to be electrically connected to the second power supply terminal included in the power supply terminal units;
a power supply trunk section configured to be electrically connected to both of the first power supply line section and the second power supply line section;
a trunk cutoff circuit located on the power supply trunk section, the trunk cutoff circuit configured to electrically disconnect the first power supply line section from the second power supply line section based on abnormality of at least one of a current value or a voltage value by cutting off a current flowing though the power supply trunk section;
a priority supply line section configured to electrically connect the priority terminal to an auxiliary portion of the power supply trunk section, the auxiliary portion located between the second power supply line section and the trunk cutoff circuit;
a normal supply line section configured to electrically connect the normal terminal to the auxiliary portion of the power supply trunk section; and
a load cutoff circuit configured to electrically disconnect, via the normal supply line section, the normal terminal from the power supply trunk section based on abnormality of the voltage value or the current value caused by a decrease in power supply of the priority supply line section in a state where the trunk cutoff circuit cuts off the current flowing through the power supply trunk section.

2. The vehicle control device according to claim 1, wherein
the priority terminal of the load terminal units is a second priority terminal,
the normal terminal of the load terminal units is a second normal terminal,
the load terminal units further include (i) a first priority terminal different from the second priority terminal and configured to be electrically connected to the priority load, and (ii) a first normal terminal different from the second normal terminal and configured to be electrically connected to the normal load,
the priority supply line section is a second priority supply line section,
the vehicle control device further comprises a first priority supply line section configured to electrically connect the first priority terminal to a main portion of the power supply trunk section, the main portion located between the first power supply line section and the trunk cutoff circuit,
the normal supply line section is a second normal supply line section,
the vehicle control device further comprises a first normal supply line section configured to electrically connect the first normal terminal to the main portion of the power supply trunk section,
the load cutoff circuit is a second load cutoff circuit, and
the vehicle control device further comprises a first load cutoff circuit configured to electrically disconnect, via the first normal supply line section, the first normal terminal from the power supply trunk section based on abnormality of the voltage value or the current value caused by a decrease in power supply of the first priority supply line section in a state where the trunk cutoff circuit is not capable of cutting off the current flowing through the power supply trunk section.

3. The vehicle control device according to claim 1, wherein
the load cutoff circuit is one of load cutoff circuits, the vehicle control device further comprising:
a first load line section configured to electrically connect the first power supply line section to the load terminal units;
a second load line section configured to electrically connect the second power supply line section to the load terminal units; and
the load cutoff circuits located in at least one of the first load line section or the second load line section and configured to electrically disconnect the power supply trunk section from the load terminal units, wherein
each of the trunk cutoff circuit and the load cutoff circuit is a cutoff circuit that includes a switching element configured to be turned on and off, and
circuitry of the load cutoff circuit is different from circuitry of the trunk cutoff circuit.

4. The vehicle control device according to claim 3, wherein
the load cutoff circuit has fewer circuit components than the trunk cutoff circuit.

5. The vehicle control device according to claim 3, wherein
the trunk cutoff circuit has two switching elements, and
the load cutoff circuit has one switching element.

6. The vehicle control device according to claim 3, wherein
the trunk cutoff circuit is configured to be turned off to cut off both (i) a current flowing from the first power supply line section to the second power supply line section and (ii) a current flowing from the second power supply line section to the first power supply line section, and
the load cutoff circuit is configured to be turned off to:
cut off a forward-direction current flowing from the first power supply line section or the second power supply line section to the load terminal units; and
allow a reverse-direction current flowing from the load terminal units to the first power supply line section or the second power supply line section.

7. The vehicle control device according to claim 1, wherein
the load cutoff circuit is one of the load cutoff circuits that are configured to cut off power supply to the load units,
the trunk cutoff circuit and the load cutoff circuits are cutoff circuits, each of which has at least one switching element and a controller,
each of the cutoff circuits is configured to share information related to abnormality of the at least one switching element,
the cutoff circuits include a first cutoff circuit and a second cutoff circuit that is associated with the first cutoff circuit,
the controller in the first cutoff circuit is configured to transmit abnormality notification signal to the second cutoff circuit in response to that the first cutoff circuit detects abnormality of the voltage value, the current value or the at least one switching element, and
the second cutoff circuit is configured to be turned off in response to receiving the abnormality notification signal.

8. The vehicle control device according to claim 3, wherein
the load cutoff circuit is configured to electrically disconnect the power supply terminal units from the load terminal units based on abnormality of at least one of the current value or the voltage value caused by a ground fault related to the load units.

9. The vehicle control device according to claim 1, further comprising:
a power supply cutoff circuit located in at least one of the first power supply line section and the second power supply line section and configured to electrically disconnect the power supply terminal units from the load terminal units.

10. The vehicle control device according to claim 9, wherein
the power supply cutoff circuit is configured to electrically disconnect the power supply terminal units from the load terminal units based on abnormality of at least one of the current value or the voltage value caused by a ground fault related to the power supply units.

11. The vehicle control device according to claim 1, wherein
the priority terminal is configured to be electrically connected to the priority load requiring redundancy.

12. The vehicle control device according to claim 2, wherein
the first priority terminal and the second priority terminal are adjacent to each other.

13. The vehicle control device according to claim 1, wherein
the trunk cutoff circuit includes an electric fuse.

14. The vehicle control device according to claim 9, wherein
the power supply cutoff circuit is configured to cut off a forward-direction current, among (i) the forward-direction current flowing from the power supply trunk section toward the load terminal units and (ii) a reverse-direction current flowing from the load terminal units toward the power supply trunk section.
